(19) United States
(12) Patent Application Publication
(10) Pub. No.: US 2025/0298333 A1
(43) Pub. Date: Sep. 25, 2025

(54) POLYESTER RESIN COMPOSITION, ELECTROSTATIC CHARGE IMAGE DEVELOPING TONER, DEVELOPER, AND IMAGE FORMING METHOD

(71) Applicant: KONICA MINOLTA, INC., Tokyo (JP)

(72) Inventors: Michiaki ISHIKAWA, Sagamihara-shi (JP); Masayuki MATSUMOTO, Yokohama-shi (JP); Minori MOMMA, Tokyo (JP); Junya ONISHI, Tokyo (JP); Aya SHIRAI, Tokyo (JP)

(73) Assignee: KONICA MINOLTA, INC., Tokyo (JP)

(21) Appl. No.: 19/079,768

(22) Filed: Mar. 14, 2025

(30) Foreign Application Priority Data
Mar. 19, 2024 (JP) 2024-043658

(51) Int. Cl. G03G 9/093; C08G 63/00; G03G 9/08; G03G 9/10

(52) U.S. Cl. CPC G03G 9/09328; C08G 63/005; G03G 9/0827; G03G 9/09364; G03G 9/10

(57) ABSTRACT

Disclosed is a polyester resin composition including a polyester resin. Among top 20 peaks in relative abundance in a chromatogram obtained by pyrolysis gas chromatography mass spectrometry, a total number N of peaks having a retention time shorter than or equal to a retention time of 4,4′-dihydroxybiphenyl is 1 to 17, and the polyester resin composition further includes at least one element selected from boron, aluminum, and phosphorus.

### BACKGROUND OF THE INVENTION

### Technical Field

The present invention relates to a polyester resin composition, an electrostatic charge image developing toner, a developer, and an image forming method.

### Description of Related Art

JP 2003-231744A discloses a polyester resin composition that includes a catalyst containing an inorganic tin (II) compound and a polyester containing no bisphenol A as a constituent monomer.

### SUMMARY OF THE INVENTION

The polyester composition disclosed in JP 2003-231744A is more susceptible to heat and more deformable in a fixing temperature range as compared with a polyester composition that includes a large amount of bisphenol derivative component as a constituent monomer of the polyester. Therefore, although such a polyester composition has good low-temperature fixability, the heat-resistant storage stability is deteriorated at the same time, and thus achieving both of them has been a problem. In addition. a toner that includes the polyester resin composition described in JP 2003-231744A tends to be brittle and have low crushing resistance. When a toner having low crushing resistance is mixed with a carrier in a developing device, the toner itself is crushed, and the crushed component covers a surface of the carrier. Therefore, the toner having low crushing resistance tends to hinder charging with a supplied toner and causes fogging and toner scattering.

The present invention has been made in view of the above-mentioned situations. An object of the present invention is to provide a polyester resin composition capable of improving low-temperature fixability, heat-resistant storage stability, and crushing resistance of a toner, an electrostatic charge image developing toner and a developer containing the polyester resin composition, and an image forming method using the developer.

To achieve at least one of the abovementioned objects, a polyester resin composition reflecting one aspect of the present invention comprises: a polyester resin composition comprising a polyester resin, wherein, among top 20 peaks in relative abundance in a chromatogram obtained by pyrolysis gas chromatography mass spectrometry, a total number N of peaks having a retention time shorter than or equal to a retention time of 4,4′-dihydroxybiphenyl is 1 to 17, and the polyester resin composition further comprises at least one element selected from boron, aluminum, and phosphorus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a chromatogram of 4,4′-dihydroxybiphenyl;

FIG. 2 is a chromatogram of a polyester resin composition according to an embodiment of the present invention;

FIG. 3 is a chromatogram of a polyester resin composition as a comparative example;

FIG. 4 is an example of a flowchart of an image forming method;

FIG. 5 is a schematic diagram illustrating an image forming apparatus that can be used in the image forming method;

FIG. 6 is a cross-sectional view of a portion of an image forming unit;

FIG. 7 is a cross-sectional view illustrating a magnetic pole arrangement in a magnet roller included in a developing roller; and

FIG. 8 is a schematic diagram illustrating a charge amount measurement device.

### DETAILED DESCRIPTION

The effects and features of one or more embodiments of the present invention will be understood from the following detailed description and the drawings. Note that the following detailed description and the drawings are provided for illustration only, and do not limit the scope of the present invention.

The following description will describe one or more embodiments of the present invention with reference to the drawings. However, the scope of the present invention is not limited to the disclosed embodiments.

In the present description, when two figures are used to indicate a range of value before and after “to”, these figures are included in the range as a lower limit value and an upper limit value.

### [1. Polyester Resin Composition]

### [1-1. Polyester Resin]

A polyester resin composition according to the present disclosure contains a polyester resin. A polyester is, for example, a polycondensate of a polyvalent carboxylic acid and a polyhydric alcohol. The polyester includes an amorphous polyester and a crystalline polyester.

The term “amorphous” means not having a melting point. In other words, the term “amorphous” means that this does not have a clear endothermic peak during temperature increase in an endothermic curve obtained by differential scanning calorimetry (DSC). The “clear endothermic peak” refers to a peak having a half value width of 15° C. or less in an endothermic curve when the temperature is increased at a temperature increase rate of 10° C./min.

The term “crystalline” means having a melting point. In other words, the term “crystalline” refers to having a clear endothermic peak during temperature increase in an endothermic curve obtained by differential scanning calorimetry (DSC). The “clear endothermic peak” refers to a peak having a half value width of 15° C. or less in an endothermic curve when the temperature is increased at a temperature increase rate of 10° C./min.

The polyester can be synthesized, for example, by esterification through polycondensation of a polyvalent carboxylic acid and a polyhydric alcohol using an esterification catalyst. The polyester thus synthesized has a structure derived from the polyvalent carboxylic acid and a structure derived from the polyhydric alcohol. The polyvalent carboxylic acid has two or more carboxy groups in one molecule. The polyhydric alcohol has two or more hydroxy groups in one molecule.

Examples of the polyvalent carboxylic acid that can be used for synthesis of the amorphous polyester include phthalic acid, isophthalic acid, terephthalic acid, trimellitic acid, naphthalene-2,6-dicarboxylic acids, malonic acid, mesaconic acid, dimethyl isophthalate, fumaric acid, dodecenyl succinic acid, and 1,10-dodecanedicarboxylic acid. Among these, dimethyl isophthalate, terephthalic acid, dodecenylsuccinic acid, and trimellitic acid are preferable. The polyvalent carboxylic acid used for the synthesis may be one type or two or more types.

Examples of the polyhydric alcohol that can be used for the synthesis of the amorphous polyester include: dihydric alcohols such as ethylene glycol, propylene glycol, butanediol, diethylene glycol, pentanediol, neopentyl glycol, hexanediol, heptanediol, cyclohexanediol, octanediol, decanediol, and dodecane diol; tri- or more valent polyols such as glycerin, pentaerythritol, hexamethylolmelamine, hexaethylolmelamine, tetramethylolbenzoguanamine, and tetraethylolbenzoguanamine; ester compounds thereof; and hydroxycarboxylic acid derivatives, bisphenol, and bisphenol derivatives. The polyhydric alcohol used for the synthesis may be one type or two or more types.

The bisphenol and bisphenol derivatives can be esterified similarly to alcohols. Therefore, in the present disclosure, the “polyhydric alcohol” includes the bisphenol and bisphenol derivatives. Examples of the bisphenol include bisphenol A and the like. Examples of the bisphenol derivatives include an ethylene oxide adduct of bisphenol A (BPA-EO) and a propylene oxide adduct of bisphenol A (BPA-PO).

The polyhydric alcohol is preferably an aliphatic polyhydric alcohol having a carbon number in a range of 5 to 7. Since an aliphatic polyhydric alcohol having a carbon number of 5 to 7 has a relatively small bulk, it is easy to make the inter-bond distances of the ester bonds uniform in the polyester obtained by synthesis. Furthermore, a portion where the density of ester groups is locally high is less likely to be formed. Specifically, it is thought that a hydrophilic moiety derived from an ester bond and a hydrophobic moiety derived from a hydrocarbon group are appropriately dispersed, thereby suppressing charge leakage.

In particular, an aliphatic polyhydric alcohol having a carbon number of 5 to 7 is less bulky than bisphenol A or a bisphenol A derivative. Therefore, it is thought that the aliphatic polyhydric alcohol having the carbon number of 5 to 7 can suppress the charge leakage as compared with bisphenol A or a bisphenol A derivative.

Examples of the aliphatic polyhydric alcohol having the carbon number of 5 to 7 include pentanediol, neopentyl glycol, hexanediol, heptanediol and cyclohexanediol.

From the viewpoint of low-temperature fixability, the proportion of the bisphenol A and bisphenol A derivatives in the polyhydric alcohol is preferably low. Specifically, the proportion of the total number of moles of the structural units derived from the bisphenol A and bisphenol A derivatives to the total number of moles of the structural units derived from the polyhydric alcohol is preferably 10 mol % or less, more preferably 5 mol % or less, even more preferably 1 mol % or less, and most preferably 0 mol %.

Examples of the polyvalent carboxylic acid that can be used for the synthesis of the crystalline polyester include: saturated aliphatic dicarboxylic acids such as oxalic acid, malonic acid, succinic acid, adipic acid, sebacic acid, azelaic acid, n-dodecylsuccinic acid, nonanedicarboxylic acid, decanedicarboxylic acid, undecanedicarboxylic acid, dodecanedicarboxylic acid (dodecanedioic acid), and tetradecanedicarboxylic acid (tetradecanedioic acid); alicyclic dicarboxylic acids such as cyclohexanedicarboxylic acid; aromatic dicarboxylic acids such as phthalic acid, isophthalic acid, and terephthalic acid; tri- or more valent polycarboxylic acid such as trimellitic acid, and pyromellitic acid; and anhydrides of these carboxylic acid compounds. In addition, other examples include alkyl esters having 1 to 3 carbon atoms.

Examples of the polyhydric alcohol that can be used for the synthesis of the crystalline polyester include: aliphatic diols such as 1,2-propanediol, 1,3-propanediol, 1,4-butanediol, 1,5-pentanediol, 1,6-hexanediol, 1,7-heptanediol, 1,8-octanediol, 1,9-nonanediol, dodecanediol, neopentyl glycol, and 1,4-butenediol; and tri- or more valent polyhydric alcohols such as glycerin, pentaerythritol, trimethylolpropane, and sorbitol.

The crystalline polyester preferably has a structural unit derived from an aliphatic diol and a structural unit derived from an aliphatic carboxylic acid. In addition, the crystalline polyester preferably has only a structural unit derived from an aliphatic diol and a structural unit derived from an aliphatic carboxylic acid.

The carbon number of the aliphatic diol or the aliphatic carboxylic acid is more preferably in a range of 6 to 10. It is thought that when the crystalline polyester has a relatively low bulky structure, the ester group can be prevented from becoming locally high in density, which can suppress the charge leakage.

The ratio of the polyhydric alcohol to the polyvalent carboxylic acid in the synthesis of the polyester is not particularly limited. The equivalent ratio of the hydroxy group of the polyhydric alcohol to the carboxy group of the polyvalent carboxylic acid is preferably within a range of 1.5/1 to 1/1.5, and more preferably within a range of 1.2/1 to 1/1.2.

Examples of a catalyst that can be used in the synthesis of the polyester include a metal-containing compound, a phosphorous acid compound, a phosphoric acid compound, and an amine compound. Examples of a metal contained in the metal-containing compound include sodium, lithium, magnesium, calcium, aluminum, zinc, manganese, antimony, titanium, tin, zirconium, and germanium. These may be used alone or in combination of two or more types thereof.

The polymerization temperature is not particularly limited but is preferably within a range of 150 to 250° C., for example. The polymerization time is not particularly limited but is preferably within a range of 0.5 to 10 hours, for example. During the polymerization, the pressure in the reaction system may be reduced as necessary.

The weight average molecular weight Mw of the polyester resin is not particularly limited. The weight average molecular weight Mw of the amorphous polyester resin is preferably within a range of 10,000 to 100,000. The weight average molecular weight Mw of the crystalline polyester resin is preferably in a range of 1000 to 29000, more preferably in a range of 1000 to 20000, and still more preferably in a range of 1000 to 15000.

The weight average molecular weight Mw of the polyester resin can be measured, for example, by the following method. An apparatus in which gel permeation chromatography “HLC-8320GPC” (manufactured by Tosoh Corporation), one column “TSKgel guardcolumn SuperHZ-L”, and three columns “TSKgel SuperHZM-M” (all manufactured by Tosoh Corporation) are connected is used. The columns (TSK−) are stabilized at 40° C., and tetrahydrofuran (THF) as a carrier solvent is flowed through the columns at the same temperature at a flow rate of 0.35 mL/min. A THF sample solution of a measurement sample adjusted to have a sample concentration of 1 mg/mL is treated using a roll mill at room temperature for 10 minutes. The solution is treated with a membrane filter having a pore size of 0.2 μm to obtain a sample solution. The sample solution (10 μL) is injected into the apparatus together with the carrier solvent, and the measurement is performed using a refractive index detector (RI detector). A calibration curve is drawn using polystyrene standard samples having a monodisperse molecular weight distribution. The molecular weight distribution of the measurement sample is calculated based on the calibration curve. The calibration curve is drawn by using 10 samples of “Polystyrene Standard Sample TSK Standard” manufactured by Tosoh Corporation: “A-500”, “F-1”, “F-10”, “F-80”, “F-380”, “A-2500”, “F-4”, “F-40”, “F-128”, and “F-700”. The data collection interval in the sample analysis is 300 ms.

The glass transition point Tg of the amorphous polyester resin is preferably in a range of 30 to 70° C., and more preferably in a range of 40 to 65° C. This makes it possible to achieve both low-temperature fixability and heat-resistant storage stability of a toner containing the amorphous polyester resin at a high level. The glass transition point Tg of the amorphous polyester resin can be controlled by the resin composition.

The glass transition point Tg can be measured, for example, by the following method. Differential scanning calorimetry (DSC measurement) is performed using a differential scanning calorimeter “DSC7000X” (manufactured by Hitachi, Ltd.) and a thermal analyzer controller “AS3/DX” (manufactured by Hitachi, Ltd.). To be specific, first, 5 mg of a sample is sealed in a sample container having cp6.8 and H2.5 mm (manufactured by Hitachi, Ltd.) for an A1 autosampler and a cover for an A1 autosampler (manufactured by Hitachi, Ltd.). This is placed in a sample holder of the “AS3/DX”, and the temperature is changed in the order of temperature increase, temperature decrease, and temperature increase. In the first and second temperature increases, the temperature is increased from 0° C. to 150° C. at a temperature increase rate of 10° C./min, and 150° C. is held for one minute. In the temperature decrease, the temperature is decreased from 150° C. to 0° C. at a temperature decrease rate of 10° C./min, and the temperature is held at 0° C. for one minute. A baseline shift in the measurement curve obtained from the second heating is determined. The intersection of an extended line of the baseline before the shift and a tangent line indicating the maximum inclination of the shifted portion of the baseline is defined as the glass transition point Tg. An empty aluminum pan is used as a reference.

The melting point Tm of the crystalline polyester resin is preferably in a range of 55 to 90° C., more preferably in a range of 60 to 85° C., and still more preferably in a range of 60 to 75° C. As a result, a toner containing the crystalline polyester resin is likely to have good low-temperature fixability and hot offset resistance. The melting point Tm of the crystalline polyester resin can be controlled by the resin composition.

The melting point Tm is a peak top temperature of an endothermic peak, and can be measured by DSC (differential scanning calorimetry). For example, differential scanning calorimetry (DSC measurement) is performed using a differential scanning calorimeter “DSC7000X” (manufactured by Hitachi, Ltd.) and a thermal analyzer controller “AS3/DX” (manufactured by Hitachi, Ltd.). To be specific, 5 mg of a sample is sealed in a sample container having cp6.8 and H2.5 mm (manufactured by Hitachi, Ltd.) for an A1 autosampler and a cover for an A1 autosampler (manufactured by Hitachi, Ltd.). This is placed in a sample holder of the “AS3/DX”, and the temperature is changed in the order of temperature increase, temperature decrease, and temperature increase. In the first and second temperature increases, the temperature is increased from 0° C. to 150° C. at a temperature increase rate of 10° C./min, and 150° C. is held for one minute. In the temperature decrease, the temperature is decreased from 150° C. to 0° C. at a temperature decrease rate of 10° C./min, and the temperature is held at 0° C. for one minute. The temperature at the top of the endothermic peak in the endothermic curve obtained from the second heating is defined as the melting point Tm. An empty aluminum pan is used as a reference.

The sum of the acid value and the hydroxyl value of the polyester resin is preferably in a range of 200 to 1000 mg KOH/g. When the sum of the acid value and the hydroxyl value is 200 mg KOH/g or more, the brittleness resistance of the polyester resin is further improved. As a result, the crushing resistance of a toner containing the polyester resin is further improved. When the sum of the acid value and the hydroxyl value is 1000 mg KOH/g or less, polymerization is sufficiently performed, and thus the heat-resistant storage stability of a toner containing the polyester resin is further improved.

The acid value of the polyester resin can be measured based on the method of JIS K 0070:1992. However, only the measurement solvent is changed from the mixed solvent of ethanol and ether specified in JIS K 0070. In the measurement of the amorphous polyester resin, the solvent is changed to a mixed solvent of acetone and toluene (acetone:toluene=1:1 (volume ratio)). In the measurement of the crystalline polyester resin, the solvent is changed to a mixed solvent of chloroform and dimethylformamide (chloroform:dimethylformamide=7:3 (volume ratio)).

The hydroxyl value of the polyester resins can be measured based on the method of JIS K 0070:1992. However, only the measurement solvent is changed from the mixed medium of ethanol and ether specified in JIS K 0070 to tetrahydrofuran.

### [1-2. Metal Elements]

The polyester resin composition according to the present disclosure further contains at least one element of boron, aluminum, and phosphorus. As described above, boron, aluminum, and phosphorus can become trivalent cations. Therefore, boron, aluminum and phosphorus improve the brittleness resistance of the polyester resin and the crushing resistance of the toner through an ionic crosslinking effect with ionized functional groups and/or imbalanced electrons in the polyester resin. In addition, boron, aluminum, and phosphorus also have an effect of improving the heat-resistant storage stability while maintaining the low-temperature fixability of the toner due to the ionic crosslinking effect.

The total content of boron, aluminum, and phosphorus is preferably within a range of 300 to 3000 ppm by mass relative to 100% by mass of the content of the polyester resin. When the total content is 300 ppm by mass or more, the crushing resistance of the toner containing the polyester resin composition is further improved. When the total content is 3000 ppm by mass or less, discoloration of the polyester resin can be prevented. This makes it possible to prevent the color of the toner containing the polyester resin composition from becoming dull.

A method for measuring the content of metal elements in the polyester resin composition is, for example, as follows. First, the polyester resin composition (three parts by mass) is added to a 0.2% by mass aqueous solution of polyoxyethylphenyl ether (35 parts by mass) to be dispersed. This dispersion liquid is treated at 25° C. for five minutes by an ultrasonic homogenizer US-1200T (manufactured by Nissei Corporation) to obtain a measurement sample. Next, an emission line of the measurement sample is obtained by acid decomposition: inductively coupled plasma-optical emission spectrometry (ICP-OES). The content of each metal element is determined from the emission line and a calibration curve prepared in advance by measuring the intensity values for a plurality of known quantities from a small amount of a standard sample of the element.

The presence form of boron, aluminum, and phosphorus in the polyester resin composition is not particularly limited. From the viewpoint of the ionic crosslinking effect, these elements are preferably present in the form of ions containing these metal elements.

These metal elements are contained in the polyester resin composition derived from, for example, metal element additives added in a production process of the polyester resin composition. The metal element additives may be esterification catalysts for synthesizing the polyester resin.

Examples of boron additives among the metal element additives include boric acid, diboron trioxide, boron trichloride, boron tribromide, boron triiodide, boron trifluoride-n-hexylamine, boron trifluoride-monoethylamine, boron trifluoride-benzylamine, boron trifluoride-diethylamine, boron trifluoride-piperidine, boron trifluoride-triethylamine, boron trifluoride-aniline, tetrafluoroborate-n-hexylamine, tetrafluoroborate-monoethylamine, tetrafluoroborate-benzylamine, tetrafluoroborate-diethylamine, tetrafluoroborate-piperidine, tetrafluoroborate-triethylamine, tetrafluoroborate-aniline, tetrahydrofuran-borane complex, and dimethyl sulfide-borane complex.

Examples of aluminum additives among the metal elemental additives include: carboxylate such as aluminum formate, aluminum acetate, basic aluminum acetate, aluminum propionate, aluminum oxalate, aluminum acrylate, aluminum laurate, aluminum stearate, aluminum benzoate, aluminum trichloroacetate, aluminum lactate, aluminum citrate, and aluminum salicylate; inorganic acid salt such as aluminum chloride, aluminum hydroxide, aluminum chloride hydroxide, aluminum carbonate, aluminum phosphate, and aluminum phosphonate; aluminum alkoxides such as aluminum methoxide, aluminum ethoxide, aluminum n-propoxide, aluminum iso-propoxide, aluminum n-butoxide, and aluminum t-butoxide; aluminum chelate compounds such as aluminum acetylacetonate, aluminum acetyl acetate, aluminum ethyl acetoacetate, and aluminum ethylacetoacetate diiso-propoxide; organoaluminum compounds such as trimethylaluminum and triethylaluminum and partial hydrolysates thereof; and aluminum oxide. Among them, carboxylates, inorganic acid salts, and chelate compounds are preferable, and aluminum acetate, basic aluminum acetate, aluminum chloride, aluminum hydroxide, aluminum hydroxide chloride, and aluminum acetylacetonate are more preferable.

The amount of the aluminum additive used is preferably from 0.001 to 1.0 mol %, more preferably from 0.005 to 0.5 mol %, relative to the number of moles of the polyvalent carboxylic acid. Since the catalytic activity largely varies depending on the types and combination of the polyvalent carboxylic acid and the polyhydric alcohol to be used and the polymerization method, the amount of the aluminum additive used is required to be in a wide range. This also applies to other polymerization catalysts. In particular, when the polymerization is not carried out under reduced pressure, it is necessary to significantly increase the amount of the polymerization catalyst. Since the polymerization catalyst according to the present disclosure exhibits sufficient catalytic activity, the obtained polyester has excellent thermal stability, thermal oxidation stability, and hydrolysis resistance, and generation of foreign matter and coloration caused by aluminum are suppressed.

Hereinafter, a specific example of a method for preparing a basic aluminum acetate aqueous solution using basic aluminum acetate as the aluminum additive will be described.

An example of the method for preparing a basic aluminum acetate aqueous solution is as follows. That is, water is added to basic aluminum acetate, and the mixture is sufficiently diffused at room temperature and then dissolved at room temperature to 100° C. to obtain an aqueous solution. In this case, the temperature is preferably low, and the heating time is preferably short. The concentration of the aqueous solution is preferably 10 to 30 g/l, particularly preferably 15 to 20 g/l.

In order to suppress heat shock at the time of catalyst addition, it is preferable that the basic aluminum acetate aqueous solution is made into a basic aluminum acetate ethylene glycol solution. That is, ethylene glycol is added to the above-described aqueous solution. The amount of ethylene glycol added is preferably 0.5 to 5.0 times the amount of the aqueous solution in terms of volume ratio. The amount is more preferably 0.8 to 2.0 times the amount. After a uniform water/ethylene glycol mixed solution is obtained by stirring the solution, the solution is heated and water is distilled off to obtain an ethylene glycol solution. The temperature is preferably not lower than 70° C. and not higher than 130° C. More preferably, water is distilled off by heating and stirring at 80 to 120° C. Still more preferably, the mixture is heated under reduced pressure and/or under an atmosphere of an inert gas such as nitrogen or argon to distill off water, thereby preparing a catalyst solution.

The above-mentioned ethylene glycol is one example, and other alkylene glycols can be used in the same manner.

The basic aluminum acetate described above is preferably solubilized in a solvent such as water or glycol, and particularly preferably solubilized in water and/or ethylene glycol. As a result, catalytic activity and foreign matter reduction can be achieved.

Examples of phosphorus additives among the metal element additives include a phosphonic acid-based compound, a phosphinic acid-based compound, a phosphine oxide-based compound, a phosphonous acid-based compound, a phosphinous acid-based compound, and a phosphine-based compound. By using these phosphorus additives, an effect of improving catalytic activity is observed, and an effect of improving physical properties such as thermal stability of the polyester is observed. Among them, the use of a phosphonic acid compound is preferable because the effect of improving the physical properties and the effect of improving the catalytic activity are large. Among the above-described phosphorus additives, a compound having an aromatic ring structure is preferable because the effect of improving the physical properties and the effect of improving the catalytic activity are large.

The phosphonic acid-based compound, the phosphinic acid-based compound, the phosphine oxide-based compound, the phosphonous acid-based compound, the phosphinous acid-based compound, and the phosphine-based compound according to the present disclosure refer to compounds having structures represented by the following Formulas 1 to 6, respectively. The symbol “*” in Formulas 1 to 6 represents a bonding site to another substituent or atom.

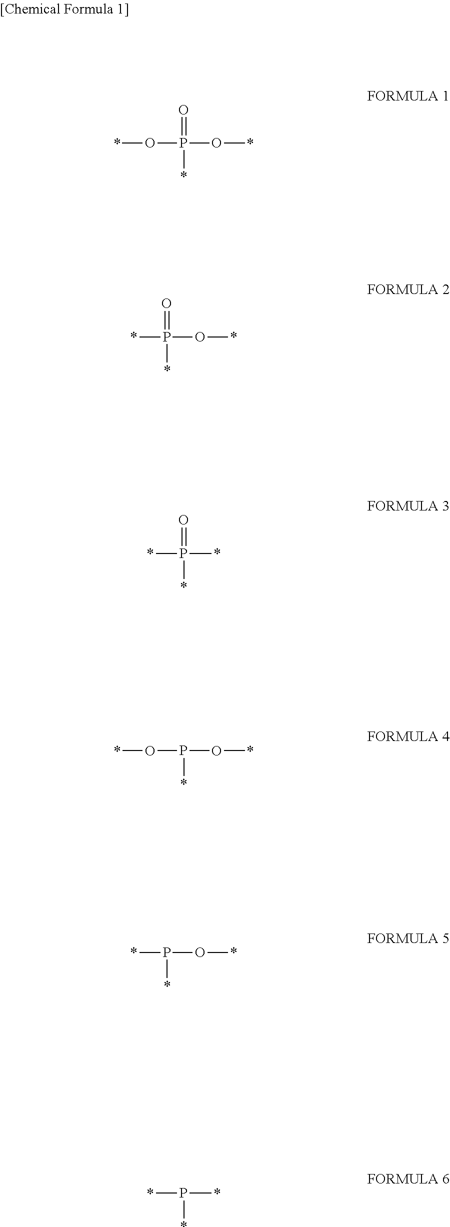

Examples of the phosphonic acid-based compound include dimethyl methylphosphonate, diphenyl methylphosphonate, dimethyl phenylphosphonate, diethyl phenylphosphonate, diphenyl phenylphosphonate, dimethyl benzylphosphonate and diethyl benzylphosphonate. Examples of the phosphinic acid-based compound include diphenylphosphinic acid, methyl diphenylphosphinate, phenyl diphenylphosphinate, phenylphosphinic acid, methyl phenylphosphinate, and phenyl phenylphosphinate. Examples of the phosphine oxide-based compound include diphenylphosphine oxide, methyldiphenylphosphine oxide, and triphenylphosphine oxide.

Among the phosphinic acid-based compounds, the phosphine oxide-based compounds, the phosphonous acid-based compounds, the phosphinous acid-based compounds, and the phosphine-based compounds, compounds represented by the following Formulas 7 to 12 are preferable.

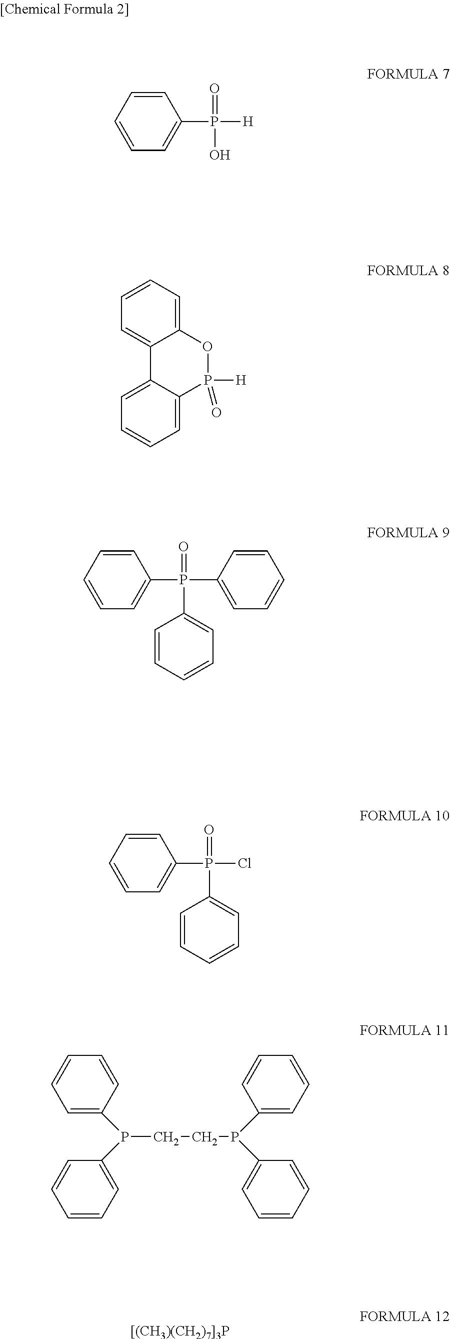

Among the above-mentioned phosphorus additives, a compound having an aromatic ring structure is preferably used because the effect of improving the physical properties and the effect of improving the catalytic activity are large.

In addition, it is preferable to use a compound represented by any one of the following General Formulas 13 to 15 as the phosphorus additive because the effect of improving the physical properties and the effect of improving the catalytic activity are particularly large.

P(═O)R¹(OR²)(OR³) General Formula 13:

P(═O)R¹R⁴(OR²) General Formula 14:

P(═O)R¹R⁵R⁶ General Formula 15:

In General Formulas 13 to 15, R¹, R⁴, R⁵, and R⁶ each independently represent a hydrogen atom, a hydrocarbon group having 1 to 50 carbon atoms, or a hydrocarbon group having 1 to 50 carbon atoms and containing a hydroxyl group, a halogen group, an alkoxy group, or an amino group. R² and R³ each independently represent a hydrogen, a hydrocarbon group having 1 to 50 carbon atoms, or a hydrocarbon group having 1 to 50 carbon atoms and containing a hydroxyl group or an alkoxyl group. The hydrocarbon group may contain an alicyclic structure or an aromatic ring structure.

As the phosphorus additive, a compound in which R¹, R⁴, Rand R⁶ in General Formulas 13 to 15 is a group having an aromatic ring structure are particularly preferable.

Examples of the phosphorus additive include dimethyl methylphosphonate, diphenyl methylphosphonate, dimethyl phenylphosphonate, diethyl phenylphosphonate, diphenyl phenylphosphonate, dimethyl benzylphosphonate, diethyl benzylphosphonate, diphenylphosphinic acid, methyl diphenylphosphinate, phenyl diphenylphosphinate, phenylphosphinic acid, methyl phenylphosphinate, phenyl phenylphosphinate, diphenylphosphine oxide, methyldiphenylphosphine oxide, and triphenylphosphine oxide. Among them, dimethyl phenylphosphonate and diethyl benzylphosphonate are particularly preferable.

Among the above-described phosphorus additives, a metal salt compound of phosphorus is particularly preferable. The metal salt compound of phosphorus is not particularly limited as long as it is a metal salt of a phosphorus additive. The metal salt compound of phosphorus is preferably a metal salt of a phosphonic acid-based compound because the effect of improving the physical properties of the polyester and the effect of improving the catalytic activity are large. Examples of the metal salt of a phosphorus additive include a monometal salt, a dimetal salt, and a trimetal salt.

Among the above-described phosphorus additives, it is preferable to use one in which the metal moiety of the metal salt is selected from Li, Na, K, Be, Mg, Sr, Ba, Mn, Ni, Cu, and Zn because the effect of improving the catalytic activity is large. Among them, Li, Na, and Mg are particularly preferable.

As the metal salt compound of phosphorus, it is preferable to use at least one selected from compounds represented by the following General Formula 16 because the effect of improving the physical properties and the effect of improving the catalytic activity are large.

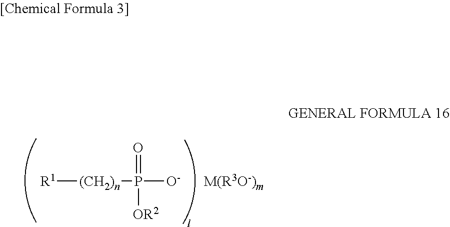

In General Formula 16, R¹ represents a hydrogen, a hydrocarbon group having 1 to 50 carbon atoms, or a hydrocarbon group having 1 to 50 carbon atoms and containing a hydroxyl group, a halogen group, an alkoxy group, or an amino group. R² represents a hydrogen, a hydrocarbon group having 1 to 50 carbon atoms, or a hydrocarbon group having 1 to 50 carbon atoms and containing a hydroxyl group or an alkoxyl group. R³ represents a hydrogen, a hydrocarbon group having 1 to 50 carbon atoms, or a hydrocarbon group having 1 to 50 carbon atoms and containing a hydroxyl group, an alkoxyl group or a carbonyl group. 1 represents an integer of 1 or more. m represents 0 or an integer of 1 or more. 1+m is equal to or less than 4. M represents a (1+m)-valent metal cation. n represents an integer of 1 or more. The hydrocarbon group may include an alicyclic structure, a branched structure, and an aromatic ring structure.

Examples of the above-mentioned R¹ include phenyl, 1-naphthyl, 2-naphthyl, 9-anthryl, 4-biphenyl, and 2-biphenyl. Examples of the above-mentioned R² include a hydrogen, a methyl group, an ethyl group, a propyl group, an isopropyl group, an n-butyl group, a sec-butyl group, a tert-butyl group, a long-chain aliphatic group, a phenyl group, a naphthyl group, a substituted phenyl group, a naphthyl group, and a group represented by —CH₂CH₂OH. Examples of R³O— include a hydroxide ion, an alcoholate ion, an acetate ion, and an acetylacetone ion.

Among the compounds represented by General Formula 16, it is preferable to use at least one selected from compounds represented by the following General Formula 17.

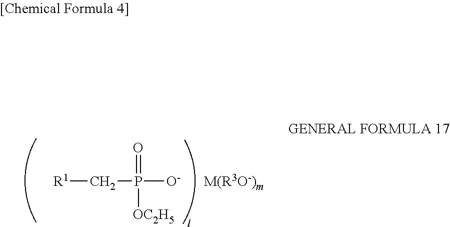

In General Formula 17, R¹ represents a hydrogen, a hydrocarbon group having 1 to 50 carbon atoms, or a hydrocarbon group having 1 to 50 carbon atoms and containing a hydroxyl group, a halogen group, an alkoxyl group, or an amino group. R³ represents a hydrogen, a hydrocarbon group having 1 to 50 carbon atoms, or a hydrocarbon group having 1 to 50 carbon atoms and containing a hydroxyl group, an alkoxyl group or a carbonyl group. 1 represents an integer of 1 or more. m represents 0 or an integer of 1 or more. 1+m is equal to or less than 4. M represents a (1+m)-valent metal cation. The hydrocarbon group may have a branched structure, an alicyclic structure, or an aromatic ring structure.

Examples of the above-mentioned R¹ include phenyl, 1-naphthyl, 2-naphthyl, 9-anthryl, 4-biphenyl, and 2-biphenyl. Examples of R³O— include a hydroxide ion, an alcoholate ion, an acetate ion, and an acetylacetone ion.

Among the above-mentioned phosphorus additives, a compound having an aromatic ring structure is preferably used because the effect of improving the physical properties and the effect of improving the catalytic activity are large.

Among the compounds represented by General Formula 17, it is preferable to use one in which M is selected from Li, Na, K, Be, Mg, Sr, Ba, Mn, Ni, Cu, and Zn because the effect of improving the catalytic activity is large. Among them, Li, Na, and Mg are particularly preferable.

Examples of the metal salt compound of phosphorus include lithium [ethyl (1-naphthyl) methylphosphonate], sodium [ethyl (1-naphthyl) methylphosphonate], magnesium bis [ethyl (1-naphthyl) methylphosphonate], potassium [ethyl (2-naphthyl) methylphosphonate], magnesium bis [ethyl (2-naphthyl) methylphosphonate], lithium [ethyl benzylphosphonate], sodium [ethyl benzylphosphonate], magnesium bis [ethyl benzylphosphonate], beryllium bis [ethyl benzylphosphonate], strontium bis [ethyl benzylphosphonate], manganese bis [ethyl benzylphosphonate], sodium benzylphosphonate, magnesium bis [benzylphosphonate], sodium [ethyl (9-anthryl) methylphosphonate], magnesium bis [ethyl (9-anthryl) methylphosphonate], sodium [ethyl 4-hydroxybenzylphosphonate], magnesium bis [ethyl 4-hydroxybenzylphosphonate], sodium [phenyl 4-chlorobenzylphosphonate], magnesium bis [ethyl 4-chlorobenzylphosphonate], sodium [methyl 4-aminobenzylphosphonate], magnesium bis [methyl 4-aminobenzylphosphonate], sodium phenylphosphonate, magnesium bis [ethyl phenylphosphonate], and zinc bis [ethyl phenylphosphonate]. Among them, lithium [ethyl (1-naphthyl) methylphosphonate], sodium [ethyl (1-naphthyl) methylphosphonate], magnesium bis [ethyl (1-naphthyl) methylphosphonate], lithium [ethyl benzylphosphonate], sodium [ethyl benzylphosphonate], magnesium bis [ethyl benzylphosphonate], sodium benzylphosphonate, and magnesium bis [benzylphosphonate] are particularly preferable.

Among the above-described phosphorus additives, a compound having at least one P—OH bond is particularly preferable. The effect of improving the physical properties of the polyester is particularly enhanced by containing such a phosphorus additive. In addition, when such a phosphorus additive is used concurrently the aluminum additive during the polymerization of the polyester, a great effect of improving the catalytic activity is observed.

The phosphorus additive having at least one P—OH bond is not particularly limited as long as it is a phosphorus additive having at least one P—OH in the molecule. Among these phosphorus additives, it is preferable to use a phosphonic acid-based compound having at least one P—OH bond because its use facilitates the formation of a complex with the aluminum additive, resulting in a great effect of improving the physical properties of the polyester and the catalytic activity.

Among the above-mentioned phosphorus additives, a compound having an aromatic ring structure is preferably used because the effect of improving the physical properties and the effect of improving the catalytic activity are large.

As the phosphorus additive having at least one P—OH bond, it is preferable to use at least one selected from compounds represented by the following General Formula 18 because the effect of improving the physical properties and the effect of improving the catalytic activity are large.

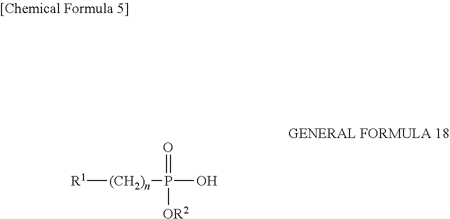

In General Formula 18, R¹ represents a hydrogen, a hydrocarbon group having 1 to 50 carbon atoms, or a hydrocarbon group having 1 to 50 carbon atoms and containing a hydroxyl group, a halogen group, an alkoxyl group, or an amino group. R² represents a hydrogen, a hydrocarbon group having 1 to 50 carbon atoms, or a hydrocarbon group having 1 to 50 carbon atoms and containing a hydroxyl group or an alkoxyl group. n represents an integer of 1 or more. The hydrocarbon group may have a branched structure, an alicyclic structure, or an aromatic ring structure.

Examples of the above-mentioned R¹ include phenyl, 1-naphthyl, 2-naphthyl, 9-anthryl, 4-biphenyl, and 2-biphenyl. Examples of the above-mentioned R² include a hydrogen, a methyl group, an ethyl group, a propyl group, an isopropyl group, an n-butyl group, a sec-butyl group, a tert-butyl group, a long-chain aliphatic group, a phenyl group, a naphthyl group, a substituted phenyl group, a naphthyl group, and a group represented by —CH₂CH₂OH.

Among the above-mentioned phosphorus additives, a compound having an aromatic ring structure is preferably used because the effect of improving the physical properties and the effect of improving the catalytic activity are large.

Examples of the phosphorus additive having at least one P—OH bond include ethyl (1-naphthyl) methylphosphonate, (1-naphthyl) methylphosphonic acid, ethyl (2-naphthyl) methylphosphonate, ethyl benzylphosphonate, benzylphosphonic acid, ethyl (9-anthryl) methylphosphonate, ethyl 4-hydroxybenzylphosphonate, ethyl 2-methylbenzylphosphonate, phenyl 4-chlorobenzylphosphonate, methyl 4-aminobenzylphosphonate, and ethyl 4-methoxybenzylphosphonate. Among them, ethyl (1-naphthyl) methylphosphonate and ethyl benzylphosphonate are particularly preferable.

Preferable examples of the phosphorus additive include phosphorus additives represented by the following General Formula 19.

R¹—CH₂—P(═O)(OR²)(OR³). General Formula 19:

In General Formula 19, R¹ represents a hydrocarbon group having 1 to 49 carbon atoms, or a hydrocarbon group having 1 to 49 carbon atoms and containing a hydroxyl group, a halogen group, an alkoxyl group, or an amino group. R² and R³ each independently represent a hydrogen, a hydrocarbon group having 1 to 50 carbon atoms, or a hydrocarbon group having 1 to 50 carbon atoms and containing a hydroxyl group or an alkoxyl group. The hydrocarbon group may have an alicyclic structure, a branched structure, or an aromatic ring structure.

The phosphorus additives are more preferably compounds in which at least one of R¹, R² and R³ in General Formula 19 contains an aromatic ring structure.

Specific examples of these phosphorus additives are listed below.

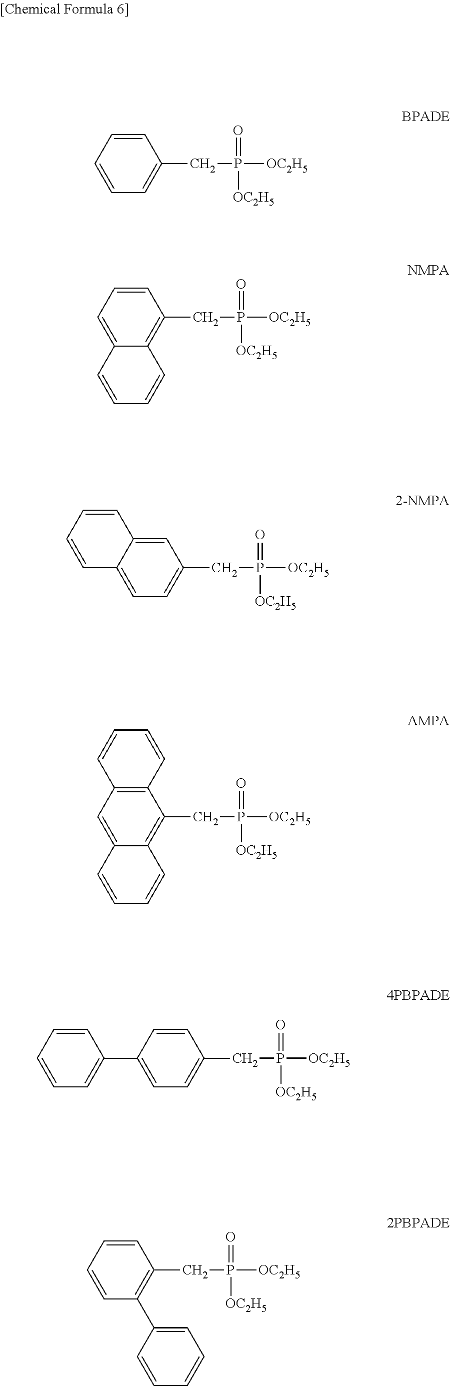 [SMILES: CCOP(=O)(Cc1ccccc1)OCC ; CCOP(=O)(Cc1cccc2ccccc12)OCC ; CCOP(=O)(Cc1ccc2ccccc2c1)OCC ; CCOP(=O)(Cc1c2ccccc2cc2ccccc12)OCC ; CCOP(=O)(Cc1ccc(-c2ccccc2)cc1)OCC ; CCOP(=O)(Cc1ccccc1-c1ccccc1)OCC]

A phosphorus additive having a large molecular weight is preferable because the phosphorus additive is less likely to be distilled off at the time of the polymerization and has a large effect.

The phosphorus additive is preferably a phosphorus additive having a phenol moiety in the same molecule. The effect of improving the physical properties of the polyester is enhanced by containing a phosphorus additive having a phenol moiety in the same molecule. In addition, by using a phosphorus additive having a phenol moiety in the same molecule at the time of the polymerization of the polyester, the effect of improving the catalytic activity is further increased, and therefore, the productivity of the polyester is excellent.

The phosphorus additive having a phenol moiety in the same molecule is not particularly limited as long as it is a phosphorus additive having a phenol structure. It is preferable to use a compound selected from the group consisting of a phosphonic acid compound, a phosphinic acid compound, a phosphine oxide compound, a phosphonous acid compound, a phosphinous acid compound, and a phosphine compound having a phenol moiety in the same molecule because the effect of improving the physical properties of the polyester and the effect of improving the catalytic activity are large. Among them, it is preferable to use the phosphonic acid compound having a phenol moiety in the same molecule because the effect of improving the physical properties of the polyester and the effect of improving the catalytic activity are particularly large.

As the phosphorus additive having a phenol moiety in the same molecule, compounds represented by the following General Formulas 20 to 22 are preferable.

P(═O)R¹(OR²)(OR³) General Formula 20:

P(═O)R¹R⁴(OR²) General Formula 21:

P(═O)R¹R⁵R⁶ General Formula 22:

In General Formulas 20 to 22, R¹ represents a hydrocarbon group having 1 to 50 carbon atoms and containing a phenol moiety. R¹ may include a substituent such as a hydroxyl group, a halogen group, an alkoxyl group, and an amino group. R⁴, R⁵ and R⁶ each independently represent a hydrogen or a hydrocarbon group having 1 to 50 carbon atoms. The hydrocarbon group having 1 to 50 carbon atoms may include a substituent such as a hydroxyl group, a halogen group, an alkoxyl group, or an amino group. R² and R³ each independently represent a hydrogen or a hydrocarbon group having 1 to 50 carbon atoms. The hydrocarbon group having 1 to 50 carbon atoms may include a substituent such as a hydroxyl group or an alkoxyl group. The hydrocarbon group may have a branched structure, an alicyclic structure, or an aromatic ring structure. The ends of R² and R⁴ may be bonded to each other.

Examples of the phosphorus additive having a phenol moiety in the same molecule include p-hydroxyphenylphosphonic acid, dimethyl p-hydroxyphenylphosphonate, diethyl p-hydroxyphenylphosphonate, diphenyl p-hydroxyphenylphosphonate, bis (p-hydroxyphenyl) phosphinic acid, methyl bis (p-hydroxyphenyl) phosphinate, phenyl bis (p-hydroxyphenyl) phosphinate, p-hydroxyphenylphenylphosphinic acid, methyl p-hydroxyphenylphenylphosphinate, phenyl p-hydroxyphenylphenylphosphinate, p-hydroxyphenylphosphinic acid, methyl p-hydroxyphenylphosphinate, phenyl p-hydroxyphenylphosphinate, bis (p-hydroxyphenyl) phosphine oxide, tris (p-hydroxyphenyl) phosphine oxide, bis (p-hydroxyphenyl) methylphosphine oxide, and compounds represented by the following Formulas 23 to 26. Among them, the compound represented by the following Formula 23 and dimethyl p-hydroxyphenylphosphonate are particularly preferable.

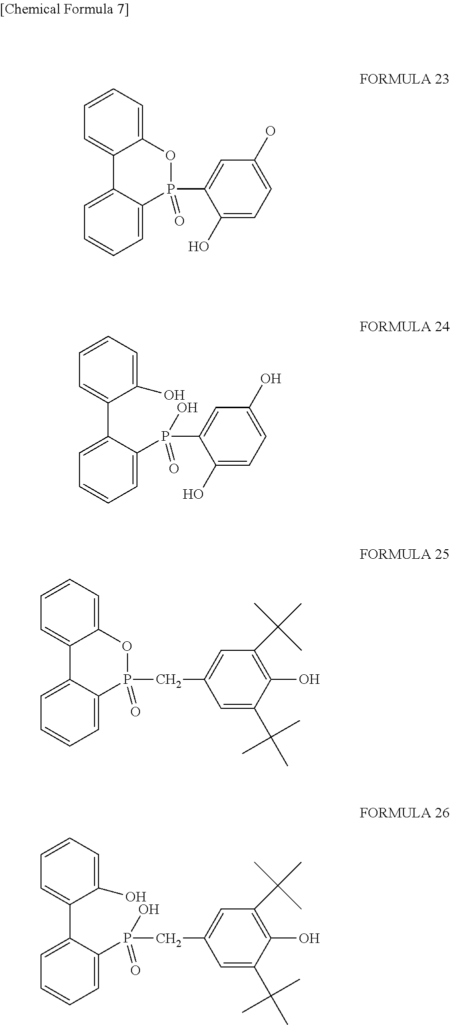 [SMILES: O=P1(c2cc(O)ccc2O)Oc2ccccc2-c2ccccc21 ; O=P(O)(c1cc(O)ccc1O)c1ccccc1-c1ccccc1O ; CC(C)(C)c1cc(CP2(=O)Oc3ccccc3-c3ccccc32)cc(C(C)(C)C)c1O ; CC(C)(C)c1cc(CP(=O)(O)c2ccccc2-c2ccccc2O)cc(C(C)(C)C)c1O]

As the compound represented by Formula 25, SANKO-220 (manufactured by Sanko Co., Ltd.) can be used.

Among the phosphorus additives having a phenol moiety in the same molecule, at least one selected from specific metal salt compounds of phosphorus represented by the following General Formula 27 is particularly preferable.

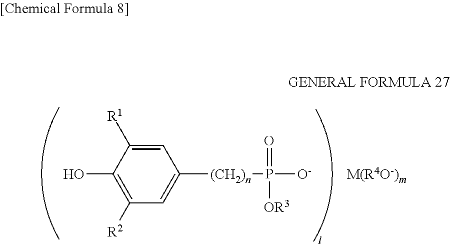

In General Formula 27, R¹ and R² each independently represent a hydrogen or a hydrocarbon group having 1 to 30 carbon atoms. R³ represents a hydrogen, a hydrocarbon group having 1 to 50 carbon atoms, or a hydrocarbon group having 1 to 50 carbon atoms and containing a hydroxyl group or an alkoxyl group. R⁴ represents a hydrogen, a hydrocarbon group having 1 to 50 carbon atoms, or a hydrocarbon group having 1 to 50 carbon atoms and containing a hydroxyl group, an alkoxyl group or a carbonyl group. Examples of R⁴O— include a hydroxide ion, an alcoholate ion, an acetate ion, and an acetylacetone ion. 1 represents an integer of 1 or more. m represents 0 or an integer of 1 or more. 1+m is equal to or less than 4. M represents a (1+m)-valent metal cation. n represents an integer of 1 or more. The hydrocarbon group may have an alicyclic structure, a branched structure, or an aromatic ring structure.

Among them, at least one selected from compounds represented by the following General Formula 28 is preferable.

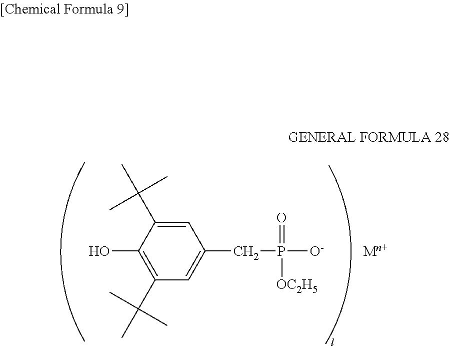

In General Formula 28, Mⁿ⁺ represents an n-valent metal cation. n represents an integer of 1 to 4.

Among the compounds represented by General Formula 27 or General Formula 28, it is preferable to use one in which M is selected from Li, Na, K, Be, Mg, Sr, Ba, Mn, Ni, Cu, and Zn because the effect of improving the catalytic activity is large. Among them, Li, Na, and Mg are particularly preferable.

Examples of specific metal-salt compounds of phosphorus include lithium [ethyl 3,5-di-tert-butyl-4-hydroxybenzylphosphonate], sodium [ethyl 3,5-di-tert-butyl-4-hydroxybenzylphosphonate], sodium [3,5-di-tert-butyl-4-hydroxybenzylphosphonate], potassium [ethyl 3,5-di-tert-butyl-4-hydroxybenzylphosphonate], magnesium-bis [ethyl 3,5-di-tert-butyl-4-hydroxybenzylphosphonate], magnesium-bis [3,5-di-tert-butyl-4-hydroxybenzylphosphonate], beryllium-bis [methyl 3,5-di-tert-butyl-4-hydroxybenzylphosphonate], strontium-bis [ethyl 3,5-di-tert-butyl-4-hydroxybenzylphosphonate], barium-bis [phenyl 3,5-di-tert-butyl-4-hydroxybenzylphosphonate], manganese-bis [ethyl 3,5-di-tert-butyl-4-hydroxybenzylphosphonate], nickel-bis [ethyl 3,5-di-tert-butyl-4-hydroxybenzylphosphonate], copper-bis [ethyl 3,5-di-tert-butyl-4-hydroxybenzylphosphonate], and zinc-bis [ethyl 3,5-di-tert-butyl-4-hydroxybenzylphosphonate]. Among them, lithium [ethyl 3,5-di-tert-butyl-4-hydroxybenzylphosphonate], sodium [ethyl 3,5-di-tert-butyl-4-hydroxybenzylphosphonate], and magnesium bis [ethyl 3,5-di-tert-butyl-4-hydroxybenzylphosphonate] are particularly preferable.

Among the phosphorus additives having a phenol moiety in the same molecule, at least one selected from specific phosphorus additives having at least one P—OH bond represented by the following General Formula 29 is particularly preferable.

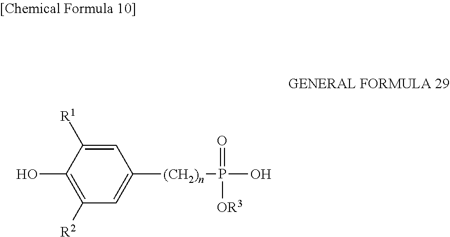

In General Formula 29, R¹ and R² each independently represent a hydrogen or a hydrocarbon group having 1 to 30 carbon atoms. R³ represents a hydrogen, a hydrocarbon group having 1 to 50 carbon atoms, or a hydrocarbon group having 1 to 50 carbon atoms and containing a hydroxyl group or an alkoxyl group. n represents an integer of 1 or more. The hydrocarbon group may have a branched structure, an alicyclic structure, or an aromatic ring structure.

Among them, at least one selected from compounds represented by the following General Formula 30 is preferable.

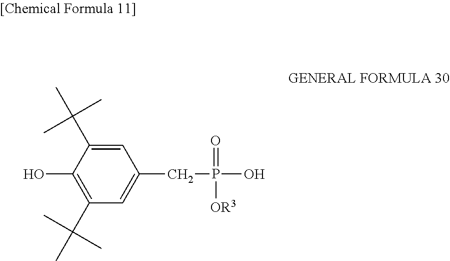

In General Formula 30, R³ represents a hydrogen, a hydrocarbon group having 1 to 50 carbon atoms, or a hydrocarbon group having 1 to 50 carbon atoms and containing a hydroxyl group or an alkoxyl group. The hydrocarbon group may have a branched structure, an alicyclic structure, or an aromatic ring structure.

Examples of the above-mentioned R³ include a hydrogen, a methyl group, an ethyl group, a propyl group, an isopropyl group, an n-butyl group, a sec-butyl group, a tert-butyl group, a long-chain aliphatic group, a phenyl group, a naphthyl group, a substituted phenyl group, a naphthyl group, and a group represented by —CH₂CH₂OH.

Examples of the specific phosphorus additives having at least one P—OH bond include ethyl 3,5-di-tert-butyl-4-hydroxybenzylphosphonate, methyl 3,5-di-tert-butyl-4-hydroxybenzylphosphonate, isopropyl 3,5-di-tert-butyl-4-hydroxybenzylphosphonate, phenyl 3,5-di-tert-butyl-4-hydroxybenzylphosphonate, octadecyl 3,5-di-tert-butyl-4-hydroxybenzylphosphonate, and 3,5-di-tert-butyl-4-hydroxybenzylphosphonate. Among them, ethyl 3,5-di-tert-butyl-4-hydroxybenzylphosphonate and methyl 3,5-di-tert-butyl-4-hydroxybenzylphosphonate are particularly preferred.

Among the phosphorus additives having a phenol moiety in the same molecule, at least one selected from specific phosphorus additives represented by the following General Formula 31 is preferable.

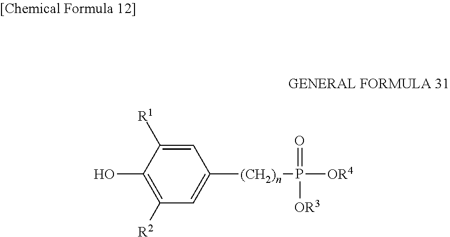

In General Formula 31, R¹ and R² each independently represent a hydrogen or a hydrocarbon group having 1 to 30 carbon atoms. R³ and R⁴ each independently represent a hydrogen, a hydrocarbon group having 1 to 50 carbon atoms, or a hydrocarbon group having 1 to 50 carbon atoms and containing a hydroxyl group or an alkoxyl group. n represents an integer of 1 or more. The hydrocarbon group may have an alicyclic structure, a branched structure, or an aromatic ring structure.

Among the compounds represented by General Formula 31, it is preferable to use at least one selected from compounds represented by the following General Formula 32 because the effect of improving the physical properties of the polyester and the effect of improving the catalytic activity are large.

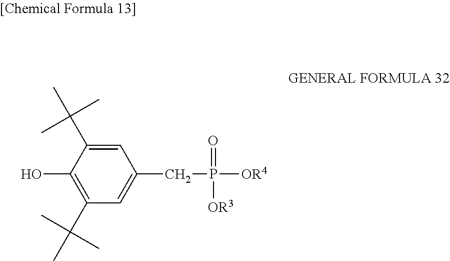

In General Formula 32, R³ and R⁴ each independently represent a hydrogen, a hydrocarbon group having 1 to 50 carbon atoms, or a hydrocarbon group having 1 to 50 carbon atoms and containing a hydroxyl group or an alkoxyl group. The hydrocarbon group may have an alicyclic structure, a branched structure, or an aromatic ring structure.

Examples of the above-mentioned R³ and R⁴ include: a short-chain aliphatic group such as a hydrogen, a methyl group, and a butyl group; a long-chain aliphatic group such as octadecyl; an aromatic group such as a phenyl group, a naphthyl group, a substituted phenyl group, and a naphthyl group; and a group represented by —CH₂CH₂OH.

Examples of the specific phosphorus additives include di-isopropyl 3,5-di-tert-butyl-4-hydroxybenzylphosphonate, di-n-butyl 3,5-di-tert-butyl-4-hydroxybenzylphosphonate, dioctadecyl 3,5-di-tert-butyl-4-hydroxybenzylphosphonate, and diphenyl 3,5-di-tert-butyl-4-hydroxybenzylphosphonate. Among them, dioctadecyl 3,5-di-tert-butyl-4-hydroxybenzylphosphonate and diphenyl 3,5-di-tert-butyl-4-hydroxybenzylphosphonate are particularly preferred.

Among the phosphorus additives having a phenol moiety in the same molecule, a particularly desirable compound is a compound represented by the following Formula 33 or 34.

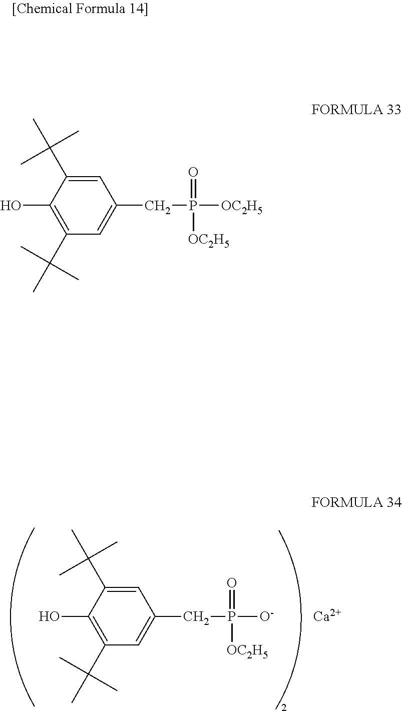

As the compound represented by the above Formula 33, Irganox 1222 (manufactured by Ciba Specialty Chemicals Inc.) is commercially available. As the compound represented by the above Formula 34, Irganox 1425 (manufactured by Ciba Specialty Chemicals Inc) is commercially available.

Other preferable examples of the phosphorus additives include a phosphonic acid compound represented by the following Formula 35 or 36 having a linking group (X) and a phosphonic acid compound represented by the following Formula 37 not having a linking group (X).

R¹—X—(P═O)(OR²)(OR³). Formula 35:

In Formula 35, R¹ represents an aromatic ring structure having 6 to 50 carbon atoms or a heterocyclic ring structure having 4 to 50 carbon atoms. The aromatic ring structure or the heterocyclic ring structure may have a substituent. X is a linking group and is selected from aliphatic hydrocarbons having 1 to 10 carbon atoms, aliphatic hydrocarbons having 1 to 10 carbon atoms containing a substituent, —O—, —OCH₂—, —SO₂—, —CO—, —COCH₂—, —CH₂OCO—, —NHCO—, —NH—, —NHCONH—, —NHSO₂—, and —NHC₃H₆OCH₂CH₂O—. The aliphatic hydrocarbons may have any of a linear structure, a branched structure, and an alicyclic structure. R² and R³ each independently represent a hydrogen, a hydrocarbon group having 1 to 20 carbon atoms, or a hydrocarbon group having 1 to 20 carbon atoms and containing a hydroxyl group or an alkoxyl group. The hydrocarbon group may have an alicyclic structure, a branched structure or an aromatic ring structure.

The substituent of the aromatic ring structure and the heterocyclic structure of the phosphorus additives represented by Formula 35 are one or more selected from the following group.
Hydrocarbon group having 1 to 50 carbon atoms (any of a straight chain structure, an alicyclic structure, a branched structure, and an aromatic ring structure may be used, and these may be halogen-substituted).
Hydroxyl group
Halogen group
Alkoxyl group having 1 to 10 carbons
Amino group (which may be substituted with alkyl or alkanol having 1 to 10 carbons)
Nitro group
Carboxy group
Aliphatic carboxylic acid ester group having 1 to 10 carbons
Formyl group
Acyl group
Sulfonic acid group
Sulfonic acid amide group (which may be substituted with alkyl or alkanol having 1 to 10 carbons)
Phosphoryl-containing group
Nitrile group
Cyanoalkyl group

Examples of the phosphorus additives represented by Formula 35 include benzylphosphonic acid, benzylphosphonic acid monoethyl ester, 1-naphthylmethylphosphonic acid, 1-naphthylmethylphosphonic acid monoethyl ester, 2-naphthylmethylphosphonic acid, 2-naphthylmethylphosphonic acid monoethyl ester, 4-phenyl,benzylphosphonic acid, 4-phenyl,benzylphosphonic acid monoethyl ester, 2-phenyl,benzylphosphonic acid, 2-phenyl,benzylphosphonic acid monoethyl ester, 4-chlorobenzylphosphonic acid, 4-chlorobenzylphosphonic acid monoethyl ester, 4-chlorobenzylphosphonic acid diethyl ester, 4-methoxy,benzylphosphonic acid, 4-methoxy,benzylphosphonic acid monoethyl ester, 4-methoxy,benzylphosphonic acid diethyl ester, 4-methyl,benzylphosphonic acid, 4-methyl,benzylphosphonic acid monoethyl ester, 4-methyl,benzylphosphonic acid diethyl ester, 4-nitro-benzylphosphonic acid, 4-nitro-benzylphosphonic acid monoethyl ester, 4-nitro-benzylphosphonic acid diethyl ester, 4-amino,benzylphosphonic acid, 4-amino,benzylphosphonic acid monoethyl ester, 4-amino,benzylphosphonic acid diethyl ester, 2-methyl,benzylphosphonic acid, 2-methyl,benzylphosphonic acid monoethyl ester, 2-methyl,benzylphosphonic acid diethyl ester, 10-anthrylmethylphosphonic acid, 10-anthrylmethylphosphonic acid monoethyl ester, 10-anthrylmethylphosphonic acid diethyl ester, (4-methoxyphenyl-, ethoxy-) methylphosphonic acid, (4-methoxyphenyl-, ethoxy-) methylphosphonic acid monomethyl ester, (4-methoxyphenyl-, ethoxy-) methylphosphonic acid dimethyl ester, (phenyl-, hydroxy-) methylphosphonic acid, (phenyl-, hydroxy-) methylphosphonic acid monoethyl ester, (phenyl-, hydroxy-) methylphosphonic acid diethyl ester, (phenyl-, chloro-) methylphosphonic acid, (phenyl-, chloro-) methylphosphonic acid monoethyl ester, (phenyl-, chloro-) methylphosphonic acid diethyl ester, (4-chlorophenyl)-iminophosphonic acid, (4-chlorophenyl)-iminophosphonic acid monoethyl ester, (4-chlorophenyl)-iminophosphonic acid diethyl ester, (4-hydroxyphenyl-, diphenyl-) methylphosphonic acid, (4-hydroxyphenyl-, diphenyl-) methylphosphonic acid monoethyl ester, (4-hydroxyphenyl-, diphenyl-) methylphosphonic acid diethyl ester, (4-chlorophenyl-, hydroxy-) methylphosphonic acid, (4-chlorophenyl-, hydroxy-) methylphosphonic acid monomethyl ester, (4-chlorophenyl-, hydroxy-) methylphosphonic acid dimethyl ester, 2-benzofuranylmethylphosphonic acid diethyl ester, 2-benzofuranylmethylphosphonic acid monoethyl ester, 2-benzofuranylmethylphosphonic acid, 2-(5-methyl) benzofuranylmethylphosphonic acid diethyl ester, 2-(5-methyl) benzofuranylmethylphosphonic acid monoethyl ester and 2-(5-methyl) benzofuranylmethylphosphonic acid. The phosphorus additives having a linking group described above is a preferred embodiment in terms of polymerization activity.

(R⁰)ₘ—R¹—(CH₂)ₙ(P═O)(OR²)(OR³). Formula 36:

In Formula 36, R⁰ represents a hydroxyl group, an alkyl group of C1 to C10, a —COOH group, a —COOR⁴ group, an alkylene glycol group, or a monoalkoxyalkylene glycol group. R⁴ represents an alkyl group of C1 to C4. The monoalkoxyalkylene glycol represents a glycol of C1 to C4. R¹ represents an aromatic ring structure such as benzene, naphthalene, biphenyl, diphenyl ether, diphenyl thioether, diphenyl sulfone, diphenylmethane, diphenyldimethylmethane, diphenyl ketone, anthracene, phenanthrene, and pyrene. R² and R³ each independently represent a hydrogen atom, a hydrocarbon group of C1 to C4, or a hydrocarbon group of C1 to C4 having a hydroxyl group or an alkoxyl group. m represents an integer of 1 to 5, and when there are a plurality of R⁰'s, they may be a combination of the same or different substituents. n represents an integer of 0 to 5.

Among the phosphorus additives represented by Formula 36, examples of the phosphorus additives in which the aromatic ring structure having a substituent is benzene include: benzylphosphonic acids having a hydroxyl group introduced into the benzene ring such as 2-hydroxybenzylphosphonic acid diethyl ester, 2-hydroxybenzylphosphonic acid monoethyl ester, 2-hydroxybenzylphosphonic acid, 4-hydroxybenzylphosphonic acid diethyl ester, 4-hydroxybenzylphosphonic acid monoethyl ester, 4-hydroxybenzylphosphonic acid, 6-hydroxybenzylphosphonic acid diethyl ester, 6-hydroxybenzylphosphonic acid monoethyl ester, and 6-hydroxybenzylphosphonic acid; benzylphosphonic acids having an alkyl group introduced into the benzene ring such as 2-n-butylbenzylphosphonic acid diethyl ester, 2-n-butylbenzylphosphonic acid monomethyl ester, 2-n-butylbenzylphosphonic acid, 3-n-butylbenzylphosphonic acid diethyl ester, 3-n-butylbenzylphosphonic acid monoethyl ester, 3-n-butylbenzylphosphonic acid, 4-n-butylbenzylphosphonic acid diethyl ester, 4-n-butylbenzylphosphonic acid monoethyl ester, 4-n-butylbenzylphosphonic acid, 2,5-n-dibutylbenzylphosphonic acid diethyl ester, 2,5-n-dibutylbenzylphosphonic acid monoethyl ester, 2,5-n-dibutylbenzylphosphonic acid, 3,5-n-dibutylbenzylphosphonic acid diethyl ester, 3,5-n-dibutylbenzylphosphonic acid monoethyl ester, and 3,5-n-dibutylbenzylphosphonic acid; benzylphosphonic acids having a carboxyl group or a carboxylic acid ester group introduced into the benzene ring such as 2-carboxybenzylphosphonic acid diethyl ester, 2-carboxybenzylphosphonic acid monoethyl ester, 2-carboxybenzylphosphonic acid, 3-carboxybenzylphosphonic acid diethyl ester, 3-carboxybenzylphosphonic acid monoethyl ester, 3-carboxybenzylphosphonic acid, 4-carboxybenzylphosphonic acid diethyl ester, 4-carboxybenzylphosphonic acid monoethyl ester, 4-carboxybenzylphosphonic acid, 2,5-dicarboxybenzylphosphonic acid diethyl ester, 2,5-dicarboxybenzylphosphonic acid monoethyl ester, 2,5-dicarboxybenzylphosphonic acid, 3,5-dicarboxybenzylphosphonic acid diethyl ester, 3,5-dicarboxybenzylphosphonic acid monoethyl ester, 3,5-dicarboxybenzylphosphonic acid, 2-methoxycarbonylbenzylphosphonic acid diethyl ester, 2-methoxycarbonylbenzylphosphonic acid monoethyl ester, 2-methoxycarbonylbenzylphosphonic acid, 3-methoxycarbonylbenzylphosphonic acid diethyl ester, 3-methoxycarbonylbenzylphosphonic acid monoethyl ester, 3-methoxycarbonylbenzylphosphonic acid, 4-methoxycarbonylbenzylphosphonic acid diethyl ester, 4-methoxycarbonylbenzylphosphonic acid monoethyl ester, 4-methoxycarbonylbenzylphosphonic acid, 2,5-dimethoxycarbonylbenzylphosphonic acid diethyl ester, 2,5-dimethoxycarbonylbenzylphosphonic acid monoethyl ester, 2,5-dimethoxycarbonylbenzylphosphonic acid, 3,5-dimethoxycarbonylbenzylphosphonic acid diethyl ester, 3,5-dimethoxycarbonylbenzylphosphonic acid monoethyl ester, and 3,5-dimethoxycarbonylbenzylphosphonic acid; benzylphosphonic acids having an alkylene glycol group or a monoalkoxylated alkylene glycol group introduced into the benzene ring such as 2-(2-hydroxyethoxy) benzylphosphonic acid diethyl ester, 2-(2-hydroxyethoxy) benzylphosphonic acid monoethyl ester, 2-(2-hydroxyethoxy) benzylphosphonic acid, 3-(2-hydroxyethoxy) benzylphosphonic acid diethyl ester, 3-(2-hydroxyethoxy) benzylphosphonic acid monoethyl ester, 3-(2-hydroxyethoxy) benzylphosphonic acid, 4-(2-hydroxyethoxy) benzylphosphonic acid diethyl ester, 4-(2-hydroxyethoxy) benzylphosphonic acid monoethyl ester, 4-(2-hydroxyethoxy) benzylphosphonic acid, 2,5-di (2-hydroxyethoxy) benzylphosphonic acid diethyl ester, 2,5-di (2-hydroxyethoxy) benzylphosphonic acid monoethyl ester, 2,5-di (2-hydroxyethoxy) benzylphosphonic acid, 3,5-di (2-hydroxyethoxy) benzylphosphonic acid diethyl ester, 3,5-di (2-hydroxyethoxy) benzylphosphonic acid monoethyl ester, 3,5-di (2-hydroxyethoxy) benzylphosphonic acid, 2-(2-methoxyethoxy) benzylphosphonic acid diethyl ester, 2-(2-methoxyethoxy) benzylphosphonic acid monoethyl ester, 1-(2-methoxyethoxy) benzylphosphonic acid, 3-(2-methoxyethoxy) benzylphosphonic acid monomethyl ester, 3-(2-methoxyethoxy) benzylphosphonic acid diethyl ester, 3-(2-methoxyethoxy) benzylphosphonic acid monoethyl ester, 3-(2-methoxyethoxy) benzylphosphonic acid, 4-(2-methoxyethoxy) benzylphosphonic acid diethyl ester, 4-(2-methoxyethoxy) benzylphosphonic acid monoethyl ester, 4-(2-methoxyethoxy) benzylphosphonic acid, 2,5-di (2-methoxyethoxy) benzylphosphonic acid diethyl ester, 2,5-di (2-methoxyethoxy) benzylphosphonic acid monoethyl ester, 2,5-di (2-methoxyethoxy) benzylphosphonic acid, 3,5-di (2-methoxyethoxy) benzylphosphonic acid diethyl ester, 3,5-di (2-methoxyethoxy) benzylphosphonic acid monoethyl ester, and 3,5-di (2-methoxyethoxy) benzylphosphonic acid.

The phosphorus additives represented by Formula 36 in which the aromatic ring structure having a substituent is benzene is not limited to the above-mentioned single substituent species. As the phosphorus additive, a compound in which the above-mentioned substituent, a hydroxyl group, an alkyl group, a carboxy group, a carboxyester group, a 2-hydroxyethoxy group, or a 2-methoxyethoxy group is mixed can also be used.

Among the phosphorus additives represented by Formula 36, examples of the phosphorus additives in which the aromatic ring structure having a substituent is naphthalene include phosphonic acids having, an alkyl group, carbocyclyl group, carboxylic acid ester group, alkylene glycol group, a monoalkoxyalkylene glycol group, or the like introduced into the naphthalene ring such as 1-(5-hydroxy) naphthylmethylphosphonic acid diethyl ester, 1-(5-hydroxy) naphthylmethylphosphonic acid monoethyl ester, 1-(5-hydroxy) naphthylmethylphosphonic acid, 1-(5-hydroxy) naphthylmethylphosphonic acid diethyl ester, 1-(5-hydroxy) naphthylmethylphosphonic acid monoethyl ester, 1-(5-hydroxy) naphthylmethylphosphonic acid, 1-(5-n-butyl) naphthylmethylphosphonic acid diethyl ester, 1-(5-n-butyl) naphthylmethylphosphonic acid monoethyl ester, 1-(5-n-butyl) naphthylmethylphosphonic acid, 1-(4-carboxy) naphthylmethylphosphonic acid diethyl ester, 1-(4-carboxy) naphthylmethylphosphonic acid monoethyl ester, 1-(4-carboxy) naphthylmethylphosphonic acid, 1-(4-methoxycarbonyl) naphthylmethylphosphonic acid diethyl ester, 1-(4-methoxycarbonyl) naphthylmethylphosphonic acid monoethyl ester, 1-(4-methoxycarbonyl) naphthylmethylphosphonic acid, 1-[4-(2-hydroxyethoxy)]naphthylmethylphosphonic acid diethyl ester, 1-[4-(2-hydroxyethoxy)]naphthylmethylphosphonic acid monoethyl ester, 1-[4-(2-hydroxyethoxy)]naphthylmethylphosphonic acid, 1-(4-methoxyethoxy) naphthylmethylphosphonic acid diethyl ester, 1-(4-methoxyethoxy) naphthylmethylphosphonic acid monoethyl ester, 1-(4-methoxyethoxy) naphthylmethylphosphonic acid, 1-(5-hydroxy) naphthylmethylphosphonic acid diethyl ester, 2-(6-hydroxy) naphthylmethylphosphonic acid diethyl ester, 2-(6-hydroxy) naphthylmonoethylphosphonic acid, 2-(6-hydroxy) naphthylmethylphosphonic acid, 2-(6-n-butyl) naphthylmethylphosphonic acid diethyl ester, 2-(6-n-butyl) naphthylmethylphosphonic acid monoethyl ester, 2-(6-n-butyl) naphthylmethylphosphonic acid, 2-(6-carboxy) naphthylmethylphosphonic acid diethyl ester, 2-(6-carboxy) naphthylmethylphosphonic acid monoethyl ester, 2-(6-carboxy) naphthylmethylphosphonic acid, 2-(6-methoxycarbonyl) naphthylmethylphosphonic acid diethyl ester, 2-(6-methoxycarbonyl) naphthylmethylphosphonic acid monoethyl ester, 2-(6-methoxycarbonyl) naphthylmethylphosphonic acid, 2-[6-(2-hydroxyethoxy)]naphthylmethylphosphonic acid diethyl ester, 2-[6-(2-hydroxyethoxy)]naphthylmethylphosphonic acid monoethyl ester, 2-[6-(2-hydroxyethoxy)]naphthylmethylphosphonic acid, 2-(6-methoxyethoxy) naphthylmethylphosphonic acid diethyl ester, 2-(6-methoxyethoxy) naphthylmethylphosphonic acid monoethyl ester, and 2-(6-methoxyethoxy) naphthylmethylphosphonic acid.

The phosphorus additives represented by Formula 36 in which the aromatic ring structure having a substituent is naphthalene is not limited to the above-mentioned single substituent species. As the phosphorus additive, a compound in which the above-mentioned substituent, a hydroxyl group, an alkyl group, a carboxy group, a carboxyester group, a 2-hydroxyethoxy group, or a 2-methoxyethoxy group is mixed can also be used.

Among the phosphorus additives represented by Formula 36, examples of the phosphorus additives in which the aromatic ring structure having a substituent is biphenyl include phosphonic acids having an alkyl group, carbocyclyl group, carboxylic acid ester group, alkylene glycol group, monomethoxyalkylene glycol group, or the like introduced into the biphenyl ring such as 4-(4-hydroxyphenyl) benzylphosphonic acid diethyl ester, 4-(4-hydroxyphenyl) benzylphosphonic acid monoethyl ester, 4-(4-hydroxyphenyl) benzylphosphonic acid, 4-(4-n-butylphenyl) benzylphosphonic acid diethyl ester, 4-(4-n-butylphenyl) benzylphosphonic acid monoethyl ester, 4-(4-n-butylphenyl) benzylphosphonic acid, 4-(4-carboxyphenyl) benzylphosphonic acid diethyl ester, 4-(4-carboxyphenyl) benzylphosphonic acid monoethyl ester, 4-(4-carboxyphenyl) benzylphosphonic acid, 4-(4-methoxycarbonylphenyl) benzylphosphonic acid diethyl ester, 4-(4-methoxycarbonylphenyl) benzylphosphonic acid monoethyl ester, 4-(4-methoxycarbonylphenyl) benzylphosphonic acid, 4-(4-hydroxyethoxyphenyl) benzylphosphonic acid diethyl ester, 4-(4-hydroxyethoxyphenyl) benzylphosphonic acid monoethyl ester, 4-(4-hydroxyethoxyphenyl) benzylphosphonic acid, 4-(4-methoxyethoxyphenyl) benzylphosphonic acid diethyl ester, 4-(4-methoxyethoxyphenyl) benzylphosphonic acid monoethyl ester, and 4-(4-methoxyethoxyphenyl) benzylphosphonic acid.

The phosphorus additives represented by Formula 36 in which the aromatic ring structure having a substituent is biphenyl is not limited to the above-mentioned single substituent species. As the phosphorus additive, a compound in which the above-mentioned substituent, a hydroxyl group, an alkyl group, a carboxy group, a carboxyester group, a 2-hydroxyethoxy group, or a 2-methoxyethoxy group is mixed can also be used.

Among the phosphorus additives represented by Formula 36, examples of the phosphorus additives in which the aromatic ring structure having a substituent is diphenyl ether include phosphonic acids having an alkyl group, carbocyclyl group, carboxylic acid ester group, alkylene glycol group, monomethoxyalkylene glycol group, or the like introduced into the diphenyl ether ring such as 4-(4-hydroxyphenyloxy) benzylphosphonic acid diethyl ester, 4-(4-hydroxyphenyloxy) benzylphosphonic acid monoethyl ester, 4-(4-hydroxyphenyloxy) benzylphosphonic acid, 4-(4-n-butylphenyloxy) benzylphosphonic acid monoethyl ester, 4-(4-n-butylphenyloxy) benzylphosphonic acid monoethyl ester, 4-(4-butylphenyloxy) benzylphosphonic acid, 4-(4-carboxyphenyloxy) benzylphosphonic acid monoethyl ester, 4-(4-carboxyphenyloxy) benzylphosphonic acid monoethyl ester, 4-(4-carboxyphenyloxy) benzylphosphonic acid, 4-(4-methoxycarbonylphenyloxy) benzylphosphonic acid monoethyl ester, 4-(4-methoxycarbonylphenyloxy) benzylphosphonic acid monoethyl ester, 4-(4-methoxycarbonylphenyloxy) benzylphosphonic acid, 4-(4-hydroxyethoxyphenyloxy) benzylphosphonic acid monoethyl ester, 4-(4-hydroxymethoxyphenyloxy) benzylphosphonic acid monoethyl ester, 4-(4-hydroxymethoxyphenyloxy) benzylphosphonic acid, 4-(4-methoxyethoxyphenyloxy) benzylphosphonic acid monoethyl ester, 4-(4-methoxyethoxyphenyloxy) benzylphosphonic acid monoethyl ester, and 4-(4-methoxyethoxyphenyloxy) benzylphosphonic acid.

The phosphorus additives represented by Formula 36 in which the aromatic ring structure having a substituent is diphenyl ether is not limited to the above-mentioned single substituent species. As the phosphorus additive, a compound in which the above-mentioned substituent, a hydroxyl group, an alkyl group, a carboxy group, a carboxyester group, a 2-hydroxyethoxy group, or a 2-methoxyethoxy group is mixed can also be used.

Among the phosphorus additives represented by Formula 36, examples of the phosphorus additives in which the aromatic ring structure having a substituent is diphenylene thioether include phosphonic acids having an alkyl group, carbocyclyl group, carboxylic acid ester group, alkylene glycol group, monomethoxyalkylene glycol group, or the like introduced into the diphenylene thioether ring such as 4-(4-hydroxyphenylthio) benzylphosphonic acid diethyl ester, 4-(4-hydroxyphenylthio) benzylphosphonic acid monoethyl ester, 4-(4-hydroxyphenylthio) benzylphosphonic acid, 4-(4-n-butylphenylthio) benzylphosphonic acid monoethyl ester, 4-(4-n-butylphenylthio) benzylphosphonic acid monoethyl ester, 4-(4-butylphenylthio) benzylphosphonic acid, 4-(4-carboxyphenylthio) benzylphosphonic acid monoethyl ester, 4-(4-carboxyphenylthio) benzylphosphonic acid monoethyl ester, 4-(4-carboxyphenylthio) benzylphosphonic acid, 4-(4-methoxycarbonylphenylthio) benzylphosphonic acid monoethyl ester, 4-(4-methoxycarbonylphenylthio) benzylphosphonic acid monoethyl ester, 4-(4-methoxycarbonylphenylthio) benzylphosphonic acid, 4-(4-hydroxyethoxyphenylthio) benzylphosphonic acid monoethyl ester, 4-(4-hydroxymethoxyphenylthio) benzylphosphonic acid monoethyl ester, 4-(4-hydroxymethoxyphenylthio) benzylphosphonic acid, 4-(4-methoxyethoxyphenylthio) benzylphosphonic acid monoethyl ester, 4-(4-methoxyethoxyphenylthio) benzylphosphonic acid monoethyl ester, and 4-(4-methoxyethoxyphenylthio) benzylphosphonic acid.

The phosphorus additives represented by Formula 36 in which the aromatic ring structure having a substituent is diphenylene thioether is not limited to the above-mentioned single substituent species. As the phosphorus additive, a compound in which the above-mentioned substituent, a hydroxyl group, an alkyl group, a carboxy group, a carboxyester group, a 2-hydroxyethoxy group, or a 2-methoxyethoxy group is mixed can also be used.

Among the phosphorus additives represented by Formula 36, examples of the phosphorus additives in which the aromatic ring structure having a substituent is diphenyl sulfone include phosphonic acids having an alkyl group, carbocyclyl group, carboxylic acid ester group, alkylene glycol group, monomethoxyalkylene glycol group, or the like introduced into the diphenyl sulfone ring such as 4-(4-hydroxyphenylsulfonyl) benzylphosphonic acid diethyl ester, 4-(4-hydroxyphenylsulfonyl) benzylphosphonic acid monoethyl ester, 4-(4-hydroxyphenylsulfonyl) benzylphosphonic acid, 4-(4-n-butylphenylsulfonyl) benzylphosphonic acid monoethyl ester, 4-(4-n-butylphenylsulfonyl) benzylphosphonic acid monoethyl ester, 4-(4-butylphenylsulfonyl) benzylphosphonic acid, 4-(4-carboxyphenylsulfonyl) benzylphosphonic acid monoethyl ester, 4-(4-carboxyphenylsulfonyl) benzylphosphonic acid monoethyl ester, 4-(4-carboxyphenylsulfonyl) benzylphosphonic acid, 4-(4-methoxycarbonylphenylsulfonyl) benzylphosphonic acid monoethyl ester, 4-(4-methoxycarbonylphenylsulfonyl) benzylphosphonic acid monoethyl ester, 4-(4-methoxycarbonylphenylsulfonyl) benzylphosphonic acid, 4-(4-hydroxyethoxyphenylsulfonyl) benzylphosphonic acid monoethyl ester, 4-(4-hydroxymethoxyphenylsulfonyl) benzylphosphonic acid monoethyl ester, 4-(4-hydroxymethoxyphenylsulfonyl) benzylphosphonic acid, 4-(4-methoxyethoxyphenylsulfonyl) benzylphosphonic acid monoethyl ester, 4-(4-methoxyethoxyphenylsulfonyl) benzylphosphonic acid monoethyl ester, and 4-(4-methoxyethoxyphenylsulfonyl) benzylphosphonic acid.

The phosphorus additives represented by Formula 36 in which the aromatic ring structure having a substituent is diphenyl sulfone is not limited to the above-mentioned single substituent species. As the phosphorus additive, a compound in which the above-mentioned substituent, a hydroxyl group, an alkyl group, a carboxy group, a carboxyester group, a 2-hydroxyethoxy group, or a 2-methoxyethoxy group is mixed can also be used.

Among the phosphorus additives represented by Formula 36, examples of the phosphorus additives in which the aromatic ring structure having a substituent is diphenylmethane include phosphonic acids having an alkyl group, carbocyclyl group, carboxylic acid ester group, alkylene glycol group, monomethoxyalkylene glycol group, or the like introduced into the diphenylmethane ring such as 4-(4-hydroxybenzyl) benzylphosphonic acid diethyl ester, 4-(4-hydroxybenzyl) benzylphosphonic acid monoethyl ester, 4-(4-hydroxybenzyl) benzylphosphonic acid, 4-(4-n-butylbenzyl) benzylphosphonic acid monoethyl ester, 4-(4-n-butylbenzyl) benzylphosphonic acid monoethyl ester, 4-(4-butylbenzyl) benzylphosphonic acid, 4-(4-carboxybenzyl) benzylphosphonic acid monoethyl ester, 4-(4-carboxybenzyl) benzylphosphonic acid monoethyl ester, 4-(4-carboxybenzyl) benzylphosphonic acid, 4-(4-methoxycarbonylbenzyl) benzylphosphonic acid monoethyl ester, 4-(4-methoxycarbonylbenzyl) benzylphosphonic acid monoethyl ester, 4-(4-methoxycarbonylbenzyl) benzylphosphonic acid, 4-(4-hydroxyethoxybenzyl) benzylphosphonic acid monoethyl ester, 4-(4-hydroxymethoxybenzyl) benzylphosphonic acid monoethyl ester, 4-(4-hydroxymethoxybenzyl) benzylphosphonic acid, 4-(4-methoxyethoxybenzyl) benzylphosphonic acid monoethyl ester, 4-(4-methoxyethoxybenzyl) benzylphosphonic acid monoethyl ester, and 4-(4-methoxyethoxybenzyl) benzylphosphonic acid.

The phosphorus additives represented by Formula 36 in which the aromatic ring structure having a substituent is diphenylmethane is not limited to the above-mentioned single substituent species. As the phosphorus additive, a compound in which the above-mentioned substituent, a hydroxyl group, an alkyl group, a carboxy group, a carboxyester group, a 2-hydroxyethoxy group, or a 2-methoxyethoxy group is mixed can also be used.

Among the phosphorus additives represented by Formula 36, examples of the phosphorus additives in which the aromatic ring structure having a substituent is diphenyldimethylmethane include phosphonic acids having an alkyl group, carbocyclyl group, carboxylic acid ester group, alkylene glycol group, monomethoxyalkylene glycol group, or the like introduced into the diphenyldimethylmethane ring such as 4-(4-hydroxyphenyldimethylmethyl) benzylphosphonic acid diethyl ester, 4-(4-hydroxyphenyldimethylmethyl) benzylphosphonic acid monoethyl ester, 4-(4-hydroxyphenyldimethylmethyl) benzylphosphonic acid, 4-(4-n-butylphenyldimethylmethyl) benzylphosphonic acid monoethyl ester, 4-(4-n-butylphenyldimethylmethyl) benzylphosphonic acid monoethyl ester, 4-(4-butylphenyldimethylmethyl) benzylphosphonic acid, 4-(4-carboxyphenyldimethylmethyl) benzylphosphonic acid monoethyl ester, 4-(4-carboxyphenyldimethylmethyl) benzylphosphonic acid monoethyl ester, 4-(4-carboxyphenyldimethylmethyl) benzylphosphonic acid, 4-(4-methoxycarbonylphenyldimethylmethyl) benzylphosphonic acid monoethyl ester, 4-(4-methoxycarbonylphenyldimethylmethyl) benzylphosphonic acid monoethyl ester, 4-(4-methoxycarbonylphenyldimethylmethyl) benzylphosphonic acid, 4-(4-hydroxyethoxyphenyldimethylmethyl) benzylphosphonic acid monoethyl ester, 4-(4-hydroxymethoxyphenyldimethylmethyl) benzylphosphonic acid monoethyl ester, 4-(4-hydroxymethoxyphenyldimethylmethyl) benzylphosphonic acid, 4-(4-methoxyethoxyphenyldimethylmethyl) benzylphosphonic acid monoethyl ester, 4-(4-methoxyethoxyphenyldimethylmethyl) benzylphosphonic acid monoethyl ester, and 4-(4-methoxyethoxyphenyldimethylmethyl) benzylphosphonic acid.

The phosphorus additives represented by Formula 36 in which the aromatic ring structure having a substituent is diphenyldimethylmethane is not limited to the above-mentioned single substituent species. As the phosphorus additive, a compound in which the above-mentioned substituent, a hydroxyl group, an alkyl group, a carboxy group, a carboxyester group, a 2-hydroxyethoxy group, or a 2-methoxyethoxy group is mixed can also be used.

Among the phosphorus additives represented by Formula 36, examples of the phosphorus additives in which the aromatic ring structure having a substituent is diphenyl ketone include phosphonic acids having an alkyl group, carbocyclyl group, carboxylic acid ester group, alkylene glycol group, monomethoxyalkylene glycol group, or the like introduced into the diphenyl ketone ring such as 4-(4-hydroxybenzoyl) benzylphosphonic acid diethyl ester, 4-(4-hydroxybenzoyl) benzylphosphonic acid monoethyl ester, 4-(4-hydroxybenzoyl) benzylphosphonic acid, 4-(4-n-butylbenzoyl) benzylphosphonic acid monoethyl ester, 4-(4-n-butylbenzoyl) benzylphosphonic acid monoethyl ester, 4-(4-butylbenzoyl) benzylphosphonic acid, 4-(4-carboxybenzoyl) benzylphosphonic acid monoethyl ester, 4-(4-carboxybenzoyl) benzylphosphonic acid monoethyl ester, 4-(4-carboxybenzoyl) benzylphosphonic acid, 4-(4-methoxycarbonylbenzoyl) benzylphosphonic acid monoethyl ester, 4-(4-methoxycarbonylbenzoyl) benzylphosphonic acid monoethyl ester, 4-(4-methoxycarbonylbenzoyl) benzylphosphonic acid, 4-(4-hydroxyethoxybenzoyl) benzylphosphonic acid monoethyl ester, 4-(4-hydroxymethoxybenzoyl) benzylphosphonic acid monoethyl ester, 4-(4-hydroxymethoxybenzoyl) benzylphosphonic acid, 4-(4-methoxyethoxybenzoyl) benzylphosphonic acid monoethyl ester, 4-(4-methoxyethoxybenzoyl) benzylphosphonic acid monoethyl ester, and 4-(4-methoxyethoxybenzoyl) benzylphosphonic acid.

The phosphorus additives represented by Formula 36 in which the aromatic ring structure having a substituent is diphenyl ketone is not limited to the above-mentioned single substituent species. As the phosphorus additive, a compound in which the above-mentioned substituent, a hydroxyl group, an alkyl group, a carboxy group, a carboxyester group, a 2-hydroxyethoxy group, or a 2-methoxyethoxy group is mixed can also be used.

Among the phosphorus additives represented by Formula 36, examples of the phosphorus additives in which the aromatic ring structure having a substituent is anthracene include phosphonic acids having an alkyl group, carbocyclyl group, carboxylic acid ester group, alkylene glycol group, monomethoxyalkylene glycol group, or the like introduced into the anthracene ring such as 9-(10-hydroxy) anthrylmethylphosphonic acid diethyl ester, 9-(10-hydroxy) anthrylmethylphosphonic acid monoethyl ester, 9-(10-hydroxy) anthrylmethylphosphonic acid, 9-(10-n-butyl) anthrylmethylphosphonic acid diethyl ester, 9-(10-n-butyl) anthrylmethylphosphonic acid monoethyl ester, 9-(10-n-butyl) anthrylylmethylphosphonic acid, 9-(10-carboxy) anthrylmethylphosphonic acid diethyl ester, 9-(10-carboxy) anthrylmethylphosphonic acid monoethyl ester, 9-(10-carboxy) anthrylmethylphosphonic acid, 9-(10-carboxy) 9-(2-hydroxyethoxy) anthrylmethylphosphonic acid diethyl ester, 9-(2-hydroxyethoxy) anthrylmethylphosphonic acid monoethyl ester, 9-(2-hydroxyethoxy) anthrylmethylphosphonic acid, 9-(2-methoxyethoxy) anthrylmethylphosphonic acid diethyl ester, 9-(2-methoxyethoxy) anthrylmethylphosphonic acid monoethyl ester, 9-(2-methoxyethoxy) anthrylmethylphosphonic acid, 9-(2-methoxycarbonyl) anthrylmethylphosphonic acid diethyl ester, 9-(2-methoxycarbonyl) anthrylmethylphosphonic acid monoethyl ester, and 9-(2-methoxycarbonyl) anthrylmethylphosphonic acid.

The phosphorus additives represented by Formula 36 in which the aromatic ring structure having a substituent is anthracene is not limited to the above-mentioned single substituent species. As the phosphorus additive, a compound in which the above-mentioned substituent, a hydroxyl group, an alkyl group, a carboxy group, a carboxyester group, a 2-hydroxyethoxy group, or a 2-methoxyethoxy group is mixed can also be used.

Among the phosphorus additives represented by Formula 36, examples of the phosphorus additives in which the aromatic ring structure having a substituent is phenanthrene include phosphonic acids having an alkyl group, carbocyclyl group, carboxylic acid ester group, alkylene glycol group, monomethoxyalkylene glycol group, or the like introduced into the phenanthrene ring such as 1-(7-n-butyl) phenanthrylmethylphosphonic acid diethyl ester, 1-(7-n-butyl) phenanthrylmethylphosphonic acid monoethyl ester, 1-(7-n-butyl) phenanthrylmethylphosphonic acid, 1-(7-carboxy) phenanthrylmethylphosphonic acid diethyl ester, 1-(7-carboxy) phenanthrylmethylphosphonic acid monoethyl ester, 1-(7-carboxy) phenanthrylmethylphosphonic acid, 1-(7-hydroxyethoxy) phenanthrylmethylphosphonic acid diethyl ester, 1-(7-hydroxyethoxy) phenanthrylmethylphosphonic acid monoethyl ester, 1-(7-hydroxyethoxy) phenanthrylmethylphosphonic acid, 1-(7-methoxyethoxy) phenanthrylmethylphosphonic acid diethyl ester, 1-(7-methoxyethoxy) phenanthrylmethylphosphonic acid monoethyl ester, 1-(7-methoxyethoxy) phenanthrylmethylphosphonic acid, 1-(7-methoxycarbonyl) phenanthrylmethylphosphonic acid diethyl ester, 1-(7-methoxycarbonyl) phenanthrylmethylphosphonic acid monoethyl ester, and 1-(7-methoxycarbonyl) phenanthrylmethylphosphonic acid.

The phosphorus additives represented by Formula 36 in which the aromatic ring structure having a substituent is phenanthrene is not limited to the above-mentioned single substituent species. As the phosphorus additive, a compound in which the above-mentioned substituent, a hydroxyl group, an alkyl group, a carboxy group, a carboxyester group, a 2-hydroxyethoxy group, or a 2-methoxyethoxy group is mixed can also be used.

Among the phosphorus additives represented by Formula 36, examples of the phosphorus additives in which the aromatic ring structure having a substituent is pyrene include phosphonic acids having an alkyl group, carbocyclyl group, carboxylic acid ester group, alkylene glycol group, monomethoxyalkylene glycol group, or the like introduced into the pyrene ring such as 1-(5-hydroxy) pyrenylmethylphosphonic acid diethyl ester, 1-(5-hydroxy) pyrenylmethylphosphonic acid monoethyl ester, 1-(5-hydroxy) pyrenylmethylphosphonic acid, 1-(5-n-butyl) pyrenylylmethylphosphonic acid diethyl ester, 1-(5-n-butyl) pyrenylmethylphosphonic acid monoethyl ester, 1-(5-n-butyl) pyrenylmethylphosphonic acid, 1-(5-carboxy) pyrenylmethylphosphonic acid diethyl ester, 1-(5-carboxy) pyrenylmethylphosphonic acid monoethyl ester, 1-(5-carboxy) pyrenylmethylphosphonic acid, 1-(5-hydroxyethoxy) pyrenylmethylphosphonic acid diethyl ester, 1-(5-hydroxyethoxy) pyrenylmethylphosphonic acid monoethyl ester, 1-(5-hydroxyethoxy) pyrenylmethylphosphonic acid, 1-(5-methoxyethoxy) pyrenylmethylphosphonic acid diethyl ester, 1-(5-methoxyethoxy) pyrenylmethylphosphonic acid monoethyl ester, 1-(5-methoxyethoxy) pyrenylmethylphosphonic acid, 1-(5-methoxycarbonyl) pyrenylmethylphosphonic acid diethyl ester, 1-(5-methoxycarbonyl) pyrenylmethylphosphonic acid monoethyl ester, and 1-(5-methoxycarbonyl) pyrenylmethylphosphonic acid.

The phosphorus additives represented by Formula 36 in which the aromatic ring structure having a substituent is pyrene is not limited to the above-mentioned single substituent species. As the phosphorus additive, a compound in which the above-mentioned substituent, a hydroxyl group, an alkyl group, a carboxy group, a carboxyester group, a 2-hydroxyethoxy group, or a 2-methoxyethoxy group is mixed can also be used.

It is presumed that a substituent such as a hydroxyl group, an alkyl group, a carboxy group, a carboxyester group, a 2-hydroxyethoxy group, or a 2-methoxyethoxy group introduced into the series of aromatic rings is deeply involved in the formation of a complex with an aluminum atom during the polymerization of the polyester. It is also thought that the phosphorus additives are particularly effective for polymerization activity, reduction of foreign matter, and the like because they have a group similar to a carboxy group or a hydroxyl group, which is a functional group at the time of forming the polyester, and are easily dissolved or incorporated into the polyester matrix.

A phosphorus additive substituted with an alkyl group of C1 to C10, a —COOH group, a —COOR⁴, an alkylene glycol group, or a monoalkoxyalkylene glycol group is preferable from the viewpoint of not only improving the catalytic activity but also reducing foreign matter as compared with an unsubstituted group in which R⁰ bonded to the aromatic ring structure (R′) is a hydrogen atom. R⁴ represents an alkyl group of C1 to C4. The monoalkoxyalkylene glycol represents a glycol of C1 to C4.

Examples of the substituent bonded to the aromatic ring structure include an alkyl group of C1 to C10, a carboxy group and a carboxy ester group, alkylene glycol, and monoalkoxyalkylene glycol. In terms of the effect of reducing foreign matter, a carboxy group, a carboxyester group, an alkylene glycol, and a monoalkoxyalkylene glycol are more preferable. The reason for this is unclear, but it is speculated to be due to an improvement in the compatibility of the polyester and the alkylene glycol, which is the catalyst medium.

R¹—(P═O)(OR²)(OR³) Formula 37:

R¹ represents an aromatic ring structure having 6 to 50 carbon atoms or a heterocyclic ring structure having 4 to 50 carbon atoms. The aromatic ring structure or the heterocyclic ring structure may have a substituent. R² and R³ each independently represent a hydrogen, a hydrocarbon group having 1 to 20 carbon atoms, or a hydrocarbon group having 1 to 20 carbon atoms and containing a hydroxyl group or an alkoxyl group. The hydrocarbon group may have an alicyclic structure, a branched structure and an aromatic ring structure.

The substituent of the aromatic ring structure and the heterocyclic structure of the phosphorus additives represented by Formula 37 are one or more selected from the following group.
Hydrocarbon group having 1 to 50 carbon atoms (any of a straight chain structure, an alicyclic structure, a branched structure, and an aromatic ring structure may be used, and these may be halogen-substituted)
Hydroxyl group
Halogen group
Alkoxyl group having 1 to 10 carbons
Amino group (which may be substituted with alkyl or alkanol having 1 to 10 carbons)
Nitro group
Carboxy group
Aliphatic carboxylic acid ester group having 1 to 10 carbons
Formyl group
Acyl group
Sulfonic acid group
Sulfonic acid amide group (which may be substituted with alkyl or alkanol having 1 to 10 carbons)
Phosphoryl-containing group
Nitrile group
Cyanoalkyl group

The aromatic ring structure in Formula 37 is selected from benzene, naphthalene, biphenyl, diphenyl ether, diphenyl thioether, diphenyl sulfone, diphenylmethane, diphenyldimethylmethane, anthracene, phenanthrene and pyrene. The heterocyclic structure in Formula 37 is selected from furan, benzofuran, isobenzofuran, dibenzofuran, naphthalane and phthalide. It is preferred that at least one of R² and R³ in Formula 37 is a hydrogen atom.

Examples of the phosphorus additives represented by Formula 37 include (3-nitro-5-methyl)-phenylphosphonic acid diethyl ester, (3-nitro-5-methyl)-phenylphosphonic acid monoethyl ester, (3-nitro-5-methyl)-phenylphosphonic acid, (3-nitro-5-methoxy)-phenylphosphonic acid diethyl ester, (3-nitro-5-methoxy)-phenylphosphonic acid monoethyl ester, (3-nitro-5-methoxy)-phenylphosphonic acid, (4-chloro)-phenylphosphonic acid diethyl ester, (4-chloro)-phenylphosphonic acid monoethyl ester, (4-chloro)-phenylphosphonic acid, (5-chloro)-phenylphosphonic acid diethyl ester, (5-chloro)-phenylphosphonic acid monoethyl ester, (5-chloro)-phenylphosphonic acid, (3-nitro-5-methyl)-phenylphosphonic acid diethyl ester, (3-nitro-5-methyl)-phenylphosphonic acid monoethyl ester, (3-nitro-5-methyl)-phenylphosphonic acid, (4-nitro)-phenylphosphonic acid diethyl ester, (4-nitro)-phenylphosphonic acid monoethyl ester, (4-nitro)-phenylphosphonic acid, (5-nitro)-phenylphosphonic acid diethyl ester, (5-nitro)-phenylphosphonic acid monoethyl ester, (5-nitro)-phenylphosphonic acid, (6-nitro)-phenylphosphonic acid diethyl ester, (6-nitro)-phenylphosphonic acid monoethyl ester, (6-nitro)-phenylphosphonic acid, (4-nitro-6-methyl)-phenylphosphonic acid diethyl ester, (4-nitro-6-methyl)-phenylphosphonic acid monoethyl ester, (4-nitro-6-methyl)-phenylphosphonic acid, a phosphorus additive obtained by removing a methylene chain that is a linking group from the phosphorus additive represented by Formula 36, 5-benzofuranylphosphonic acid diethyl ester, 5-benzofuranylphosphonic acid monoethyl ester, 5-benzofuranylphosphonic acid, 5-(2-methyl) benzofuranylphosphonic acid diethyl ester, 5-(2-methyl) benzofuranylphosphonic acid monoethyl ester, and 5-(2-methyl) benzofuranylphosphonic.

Phosphorus additives have been known as thermal stabilizers for polyesters. However, it has not previously been known that the use of these compounds in combination with conventional metal-containing polyester polymerization catalysts significantly promotes melt polymerization. In fact, when a polyester is melt-polymerized using an antimony compound, a titanium compound, a tin compound or a germanium compound as a typical catalyst, it is not recognized that addition of a phosphorus additive promotes polymerization to a substantially useful level.

On the other hand, it is preferable to use at least one selected from alkali metals, alkaline earth metals, and compounds thereof as a second metal-containing component concurrently with the aluminum additive. The concurrent use of such a second metal-containing component is preferred because incorporation into a glycol component to be distilled off during polymerization is more suppressed than in the case of the concurrent use of the above-described phosphorus additive. When a dicarboxylic acid and an alkylene oxide adduct such as bisphenol A or F form a secondary glycol such as propylene oxide in particular, the concurrent use of the above-described second metal-containing component, in particular, a lithium compound in the catalyst system dramatically increases the catalytic activity. Thus, a catalyst component having a further increased reaction rate can be obtained, which is effective in improving productivity. When the polymerization temperature needs to be kept low, for example, at 240 to 260° C., it is preferable to use the second metal-containing component, particularly a lithium compound, concurrently in the catalyst system because the polymerization activity can be imparted by increasing the addition amount. Further, by adding a small amount of a phosphorus additive to a system containing the aluminum compound and an alkali metal and/or an alkaline earth metal, a preferable catalytic activity is also exhibited.

The second alkaline earth metal is preferably at least one selected from Li, Na, K, Rb, Cs, Be, Mg, Ca, Sr, And Ba. Among them, at least one selected from Li, Na, Mg, and compounds thereof is more preferably used. Among them, Li is most preferable. Examples of the compound of an alkali metal or an alkaline earth metal include: saturated aliphatic carboxylates such as formic acid, acetic acid, propionic acid, butyric acid, and oxalic acid; unsaturated aliphatic carboxylates such as acrylic acid, and methacrylic acid; aromatic carboxylates such as benzoic acid; halogen-containing carboxylates such as trichloroacetic acid; hydroxycarboxylic acid salts such as lactic acid, citric acid, and salicylic acid; inorganic acid salts such as carbonic acid, sulfuric acid, nitric acid, phosphoric acid, phosphonic acid, bicarbonate, hydrogen phosphate, hydrogen sulfide, sulfurous acid, thiosulfate, hydrochloric acid, hydrobromic acid, chloric acid, and bromate; organic sulfonates such as 1-propanesulfonic acid, 1-pentanesulfonic acid, and naphthalenesulfonic acid; organic sulfates such as lauryl sulfate; alkoxides such as methoxy, ethoxy, n-propoxy, iso-propoxy, n-butoxy, and tert-butoxy; chelate compound with acetylacetonate or the like; hydride; oxide; and hydroxide.

Among these alkali metals, alkaline earth metals, and compounds thereof, when a strong alkaline compound such as hydroxide is used, such a compound tends to be difficult to dissolve in organic solvents, such as diols, e.g., ethylene glycol, or alcohols. Therefore, an aqueous solution must be added to the polymerization system, which may cause a problem in a polymerization process. Furthermore, when a strong alkaline compound such as hydroxide is used, the polyester tends to undergo a side reaction such as hydrolysis during polymerization, and the polymerized polyester tends to be easily colored, and the hydrolysis resistance also tends to decrease. Therefore, preferable examples of an alkali metal, an alkaline earth metal or a compound thereof include: a saturated aliphatic carboxylate, an unsaturated aliphatic carboxylate, an aromatic carboxylate, a halogen-containing carboxylate, and a hydroxycarboxylic acid salt of the alkali metal or the alkaline earth metal; an inorganic acid salt selected from sulfuric acid, nitric acid, phosphoric acid, phosphonic acid, hydrogen phosphate, hydrogen sulfide, sulfurous acid, thiosulfuric acid, hydrochloric acid, hydrobromic acid, chloric acid and bromic acid; an organic sulfonate; an organic sulfate; a chelate compound; and an oxide. Among them, a saturated aliphatic carboxylate of an alkali metal or an alkaline earth metal, particularly an acetate is preferable from the viewpoint of ease of handling and availability, and the like

It is also possible to use a combination of two or more catalysts.

### [1-3. Thermal Decomposition Characteristics]

In the polyester resin composition according to the present disclosure, the total number N of peaks having a retention time shorter than or equal to the retention time of 4,4′-dihydroxybiphenyl is 1 to 17 among top 20 peaks in relative abundance in a chromatogram obtained by pyrolysis gas chromatography mass spectrometry. In the polyester resin composition having a number N of 1 or more, the molecular difference cleavage energy and the molecular weight of the components after thermal decomposition are relatively small, and the polarity of the components after thermal decomposition is strong. Such a polyester resin composition is easily influenced by heat and improves the low-temperature fixability of the toner. Further, since the polyester resin composition according to the present disclosure has a number N of 17 or less, even if the polyester resin composition is thermally decomposed, the amount of the short molecular chain components is not too large, and thus the crushing resistance of the toner is not lowered.

The number N can be controlled by selecting the structure, molecular weight, dispersibility, polarity, and the like of the thermally decomposed components of the polyester resin. The number N can also be controlled by adjusting the amount of monomers, reaction conditions, and the like in synthesizing the polyester resin. For example, the number N can be controlled to 1 to 17 by not using bisphenol A or bisphenol A derivatives as the polyhydric alcohol used in synthesizing the polyester resin. On the other hand, for example, when all the polyhydric alcohols used in the synthesis of the polyester resin are bisphenol A or bisphenol A derivatives, the number N is 0 because the thermally decomposed products are retained in a column by the interaction between the molecular weight and the polarity. In addition, for example, when the polyester resin is synthesized by ring-opening polymerization of L-lactone, the retention time of the thermally decomposed products is relatively short, and thus the number N becomes 18 or more.

An analyzer used for pyrolysis gas chromatograph mass spectrometry (pyrolysis GC/MS) is a gas chromatograph mass spectrometer in which a pyrolyzer is installed in a sample introduction section. The analyzer includes a pyrolyzer, a gas chromatograph, and a mass spectrometer. In the pyrolyzer, a sample is instantaneously heated in an inert atmosphere and then decomposed into small molecules. The decomposed small molecules of various types are column separated by the gas chromatograph. Each separated component is detected by the mass spectrometer to obtain a chromatogram.

In the pyrolysis process by the pyrolyzer, the thermal vibration of a molecule itself, generated by applying thermal energy to the sample, leads to an irreversible cleavage and/or irreversible physical state change of a molecular bonding portion that has become locally unable to withstand the thermal vibration. In the gas chromatography process by the gas chromatograph, the decomposed small molecules are introduced into a column together with a carrier gas. Due to the interaction between the small molecules and the stationary phase in the column, which is related to the physical properties of the small molecules such as molecular weight, molecular structure, polarity, and dispersibility, the small molecules move through the column while repeating adsorption to and distribution from the stationary phase. As a result, there are differences in the time it takes for the small molecules to arrive at the column outlet, and thus the small molecules are separated. The mass of the small molecule is detected in the mass spectrometer, and the amount of the detected small molecule with respect to the retention time is represented as a peak in the chromatogram.

The time it takes for a peak to appear after injecting a sample is called the retention time. The retention time is different for different small molecules and is highly reproducible. Therefore, the retention time is a crucial factor in determining the identity of the component.

In the pyrolysis GC/MS according to the present disclosure, 4,4′-dihydroxybiphenyl does not necessarily have to be detected as a pyrolysate because the retention time of 4,4′-dihydroxybiphenyl is an indicator. However, it is necessary to analyze 4,4′-dihydroxybiphenyl alone under the same analysis conditions and know the retention time thereof.

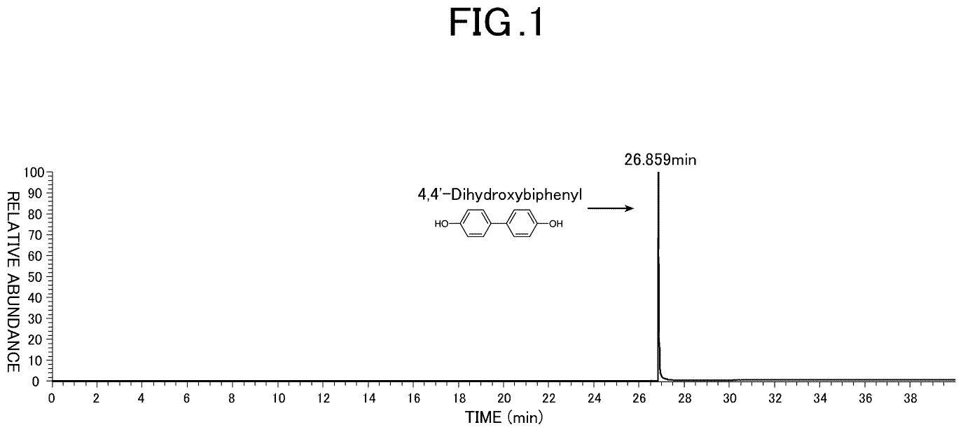

FIG. 1 is a chromatogram of 4,4′-dihydroxybiphenyl alone obtained by pyrolysis GC/MS under certain conditions. The horizontal axis of the chromatogram represents the retention time [min]. The vertical axis of the chromatogram represents relative abundance. It can be confirmed from the chromatogram that the retention time of 4,4′-dihydroxybiphenyl under the aforementioned conditions is 26.859 min.

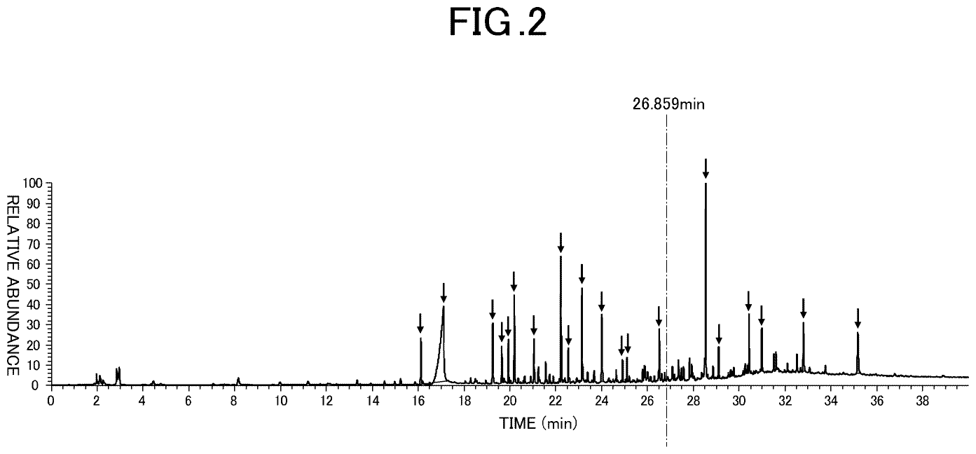

FIG. 2 is a chromatogram of a polyester resin composition according to an embodiment of the present invention obtained by pyrolysis GC/MS under the same conditions as those described above. Peaks indicated by arrows in FIG. 2 are the top 20 peaks in relative abundance in the chromatogram. Among the 20 peaks, the total number N of peaks having a retention time shorter than or equal to the retention time (26.859 min) of 4,4′-dihydroxybiphenyl is 14. The polyester resin contained in the polyester resin composition does not contain bisphenol A or a bisphenol A derivative as a constituent monomer, that is, does not have a structural unit derived from bisphenol A or a structural unit derived from a bisphenol A derivative.

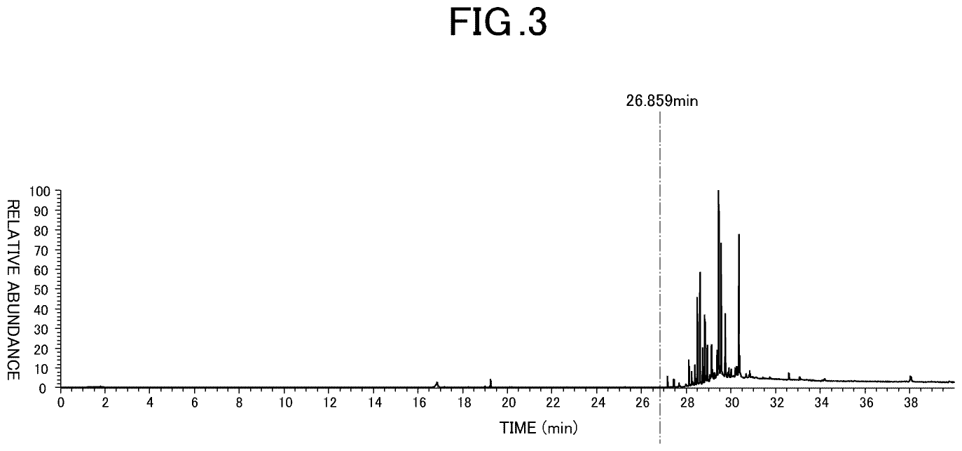

FIG. 3 is a chromatogram of a polyester resin composition as a comparative example, which is obtained by pyrolysis GC/MS under the same conditions as above. Among the top 20 peaks in relative abundance in the chromatogram, the total number N of peaks having a retention time shorter than or equal to the retention time of 4,4′-dihydroxybiphenyl (26.859 mm) is zero. The polyester resin contained in the polyester resin composition contains a bisphenol A derivative as a constituent monomer, that is, has a structural unit derived from a bisphenol A derivative.

Detailed conditions of the pyrolysis GC/MS are not particularly limited and can be, for example, conditions as described in Examples described later.

### [2. Electrostatic Charge Image Developing Toner]

The polyester resin composition according to the present disclosure can be contained in, for example, an electrostatic charge image developing toner. In the present specification, the term “electrostatic charge image developing toner” is also referred to simply as a “toner”. The “toner” refers to an aggregate of toner particles. The toner particles include, for example, toner base particles and an external additive.

The toner preferably contains the above-described polyester resin composition according to the present disclosure in an amount of 30 to 97% by mass relative to the total amount of the toner (including the external additive). When the content of the polyester resin composition is 30% by mass or more, the toner has better low-temperature fixability, heat-resistant storage stability, and crushing resistance. When the content of the polyester resin composition is 97% by mass or less, other components such as an external additive contributing to improvement of heat-resistant storage stability can be contained in a necessary amount or more. In a toner containing a colorant, a release agent, and an external additive, the content of the polyester resin composition is more preferably 90.2% by mass or less. In a toner not containing a colorant, the content of the polyester resin composition is more preferably 95.1% by mass or less. The polyester resin composition is contained, for example, as a binder resin in the toner base particles.

The toner base particles may contain other resins, a release agent, a colorant, a charge control agent, and other additives in addition to the polyester resin composition.

The other resins include, for example, a vinyl resin. The vinyl resin is a resin obtained by polymerization using at least a vinyl-based monomer. Specific examples of the vinyl resin include an acrylic resin and a styrene-acrylic copolymer resin.

Examples of a polymerizable monomer used in the styrene-acrylic resin include an aromatic vinyl monomer and a (meth)acrylic acid ester-based monomer.

Examples of the aromatic vinyl monomer include styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, 3,4-dichlorostyrene, and derivatives thereof. These aromatic vinyl monomers may be used alone or in combination of two or more.

Examples of the (meth)acrylic ester monomer include methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl j3-hydroxyacrylate, γ-propyl aminoacrylate, stearyl methacrylate, dimethylaminoethyl methacrylate, and diethylaminoethyl methacrylate. These (meth)acrylic acid ester monomers may be used alone or in combination of two or more.

Among the above, it is preferable to use a styrene-based monomer in combination with an acrylate ester-based monomer or a methacrylate ester-based monomer.

As the polymerizable monomer, a third vinyl-based monomer can also be used. Examples of the third vinyl-based monomer include acid monomers such as acrylic acid, methacrylic acid, maleic anhydride, and vinyl acetate, acrylamide, methacrylamide, acrylonitrile, ethylene, propylene, butylene vinyl chloride, N-vinylpyrrolidone, and butadiene.

As the polymerizable monomer, a polyfunctional vinyl-based monomer may be further used. Examples of the polyfunctional vinyl monomer include diacrylates such as ethylene glycol, propylene glycol, butylene glycol, and hexylene glycol, and dimethacrylates and trimethacrylates of tertiary or higher alcohols such as divinylbenzene, pentaerythritol, and trimethylolpropane. The copolymerization ratio of the polyfunctional vinyl monomer to the entire polymerizable monomers is usually in a range of 0.001 to 5% by mass, preferably in a range of 0.003 to 2% by mass, and more preferably in a range of 0.01 to 1% by mass.

Example of the release agent that the toner base particles may contain include wax. Examples of the wax include: hydrocarbon waxes such as low molecular weight polyethylene wax, low molecular weight polypropylene wax, Fischer-Tropsch wax, microcrystalline wax, and paraffin wax; and ester waxes such as carnauba wax, pentaerythritol behenic acid ester, behenyl behenate and behenyl citrate. These may be used alone or in combination of two or more.

The melting point of the release agent is preferably in a range of 50 to 95° C. from the viewpoint of improving the low-temperature fixability and releasability of the toner.

The melting point of the release agent is determined by differential scanning calorimetry. For the differential scanning calorimetry, for example, a differential scanning calorimeter “Diamond DSC” (manufactured by PerkinElmer, Inc.) can be used. The measurement is performed under the following conditions (heating and cooling conditions): the first heating process raises the temperature from 0° C. to 200° C. at a heating rate of 10° C./min and holds it isothermally at 200° C. for five minutes; the cooling process cools the temperature from 200° C. to 0° C. at a cooling rate of 10° C./min and holds it isothermally at 0° C. for five minutes; and the second heating process raises the temperature from 0° C. to 200° C. at a heating rate of 10° C./min. The above measurement is carried out by sealing 3.0 mg of the release agent in an aluminum pan and setting the pan in a sample holder of a differential scanning calorimeter “Diamond DSC”. An empty aluminum pan is used as a reference. In the measurement, an endothermic curve obtained in the second heating process is analyzed, and the temperature at the top of the endothermic peak derived from the release agent component is defined as the melting point [° C.].

The content of the release agent is preferably in a range of 2 to 20% by mass, more preferably in a range of 3 to 18% by mass, and still more preferably in a range of 4 to 15% by mass relative to the total amount of the resin contained in the toner base particles.

Examples of the colorant that the toner base particles may contain include carbon black, a magnetic material, a dye, and a pigment.

Examples of the carbon black include channel black, furnace black, acetylene black, thermal black, and lamp black.

Examples of the magnetic material include ferromagnetic metals such as iron, nickel, and cobalt, alloys containing these metals, and compounds of ferromagnetic metals such as ferrite and magnetic.

Examples of the pigment include phthalocyanine pigments such as C.I. Pigment Red 2, 3, 5, 7, 15, 16, 48:1, 48:3, 53:1, 57:1, 81:4, 122, 123, 139, 144, 149, 166, 177, 178, 208, 209, 222, C.I. Pigment Orange 31, 43, C.I. Pigment Yellow 3, 9, 14, 17, 35, 36, 65, 74, 83, 93, 94, 98, 110, 111, 138, 139, 153, 155, 180, 181, 185, C.I. Pigment Green 7, C.I. and Pigment Blue 15:3, 15:4, 60, and phthalocyanine pigments with central metals such as zinc, titanium, and magnesium, and mixtures thereof can also be used.

Examples of the dyes include C.I. Solvent Red 1, 3, 14, 17, 18, 22, 23, 49, 51, 52, 58, 63, 87, 111, 122, 127, 128, 131, 145, 146, 149, 150, 151, 152, 153, 154, 155, 156, 157, 158, 176, 179, pyrazolo-triazole azo dye, pyrazolo-triazole azomethine dye, pyrazolone azo dye, pyrazolone azomethine dye, C.I. Solvent Yellow 19, 44, 77, 79, 81, 82, 93, 98, 103, 104, 112, 162, C.I. Solvent Blue 25, 36, 60, 70, 93, and 95, and mixtures thereof can also be used.

The content of the colorant is preferably in a range of 1 to 30% by mass and more preferably in a range of 2 to 20% by mass relative to the total amount of the resin contained in the toner base particles.

Various known materials can be used as the charge control agent that the toner base particles may contain.

As the charge control agent, for example, various known compounds that can be dispersed in an aqueous medium can be used. Specific examples of the charge control agent include a nigrosine dye, a metal salt of naphthenic acid or a higher fatty acid, an alkoxylated amine, a quaternary ammonium salt compound, an azo metal complex, and a metal salt of salicylic acid or a metal complex thereof.

The content of the charge control agent is preferably in a range of 0.1 to 10.0% by mass and more preferably in a range of 0.5 to 5.0% by mass relative to the total amount of the resin contained in the toner base particles.

The toner base particles may contain other additives as necessary. Examples of the other additives include magnetic powders, fluidity improvers, conductivity modifiers, reinforcing fillers such as fibrous substances, antioxidants, and cleanability improvers.

The average circularity of the toner is preferably in a range of 0.950 to 0.995 from the viewpoint of improving the crushing resistance. The average circularity of the toner is measured using “FPIA-2100” (manufactured by Sysmex Corporation). Specifically, first, a sample (toner) is wetted with an aqueous surfactant-containing solution and subjected to an ultrasonic dispersion treatment for one minute for dispersion. Thereafter, imaging is performed with “FPIA-2100” (manufactured by Sysmex Corporation) under measurement conditions of an HPF (high-power field imaging) mode at an appropriate density corresponding to an HPF detection number of 3000 to 10000. The circularity of each toner particle is calculated according to the following Formula (T), the circularity of each toner particle is summed, and the sum is divided by the total number of toner particles. Thus, the average circularity is calculated.

Circularity=(Perimeter of a circle having the same projected area as the particle image)/(Perimeter of the particle projection image) Formula (T):

The toner may contain an external additive added as a post-treatment agent to the surfaces of the toner base particles in order to enhance the fluidity, chargeability, and cleanability of the toner particles.

The external additive is preferably inorganic particles such as silica particles, alumina particles, zirconia particles, titanium oxide particles, strontium titanate particles, zinc oxide particles, chromium oxide particles, cerium oxide particles, antimony oxide particles, tungsten oxide particles, tin oxide particles, tellurium oxide particles, manganese oxide particles, and boron oxide particles. These inorganic particles may be subjected to a hydrophobic treatment with a surface treatment agent such as a silane coupling agent or silicone oil, if necessary.

The number average primary particle size of the inorganic particles is preferably in a range of 20 to 200 nm, more preferably in a range of 30 to 150 nm. As the number average primary particle size of the external additive, an average value of horizontal Feret diameters measured for 100 particles obtained by binarizing image data captured by a scanning electron microscope (SEM) using an image processing analyzer (LUZEX AP manufactured by Nireco Corporation) can be used.

The external additive may be organic particles. Examples of the organic particles include particles of a homopolymer of styrene, a homopolymer of methyl methacrylate, and a copolymer of styrene and methyl methacrylate. The particle size of the organic particles at the peak top measured by the same method as that of the inorganic particles is preferably in a range of 10 to 1000 nm.

The external additive may be a lubricant, such as a metal salt of a higher fatty acid. Examples of the higher fatty acid include stearic acid, oleic acid, palmitic acid, linoleic acid, and ricinoleic acid. Examples of the metal constituting the metal salt include zinc, manganese, aluminum, iron, copper, magnesium, and calcium.

The content of the external additive is preferably in a range of 0.05 to 10.00% by mass and more preferably in a range of 0.10 to 5.00% by mass relative to the total amount of the toner. The external additive contained in the toner may be one type or two or more types.

A method for producing the toner is not particularly limited, and may be an emulsion aggregation method, a kneading and pulverizing method, or the like.

Hereinafter, as an example of the method for producing the toner, a production method that includes a process of forming toner base particles having a core-shell structure by an emulsion aggregation method will be described.

First, an aqueous dispersion in which a particle dispersion of various binder resins, a release agent particle dispersion, and a colorant particle dispersion are dispersed in an aqueous medium is prepared.

The aqueous dispersion means a dispersion in which a dispersion element (particles) is dispersed in an aqueous medium containing water as a main component (50% by mass or more). The aqueous medium may contain a water-soluble organic medium in addition to water. Examples of the water-soluble organic medium include methanol, ethanol, isopropanol, butanol, acetone, methyl ethyl ketone, and tetrahydrofuran.

An aggregating agent such as aluminum sulfate is added to the aqueous dispersion, and the dispersion element is agglomerated by heating the mixture to form core particles.

Separately prepared shell-forming resin particles are added to the dispersion of the core particles. Thus, the shell-forming resin particles are aggregated on the surfaces of the core particles. Thus, toner base particles having a core-shell structure are formed.

After the toner base particles are formed, the toner base particles and an external additive are mixed to obtain a toner having the toner base particles and the external additive.

### [3. Developer]

The toner may be used as a magnetic or non-magnetic mono-component developer, but is preferably mixed with a carrier to be used as a two-component developer.

As the carrier, for example, magnetic particles formed of a conventionally known material can be used. Examples of the magnetic particles include metals such as iron, ferrite, and magnetic, and alloys of these metals and metals such as aluminum and lead. As the carrier, ferrite particles are particularly preferable.

Coated carrier particles or dispersed carrier particles may be used as the carrier. The “coated carrier particles” are particles obtained by coating the surfaces of magnetic particles with a coating agent such as a resin. The “dispersed carrier particles” are particles in which a magnetic fine powder is dispersed in a binder resin. The carrier is preferably coated carrier particles from the viewpoint of suppressing adhesion of the carrier to a photoreceptor.

The specific weight of the carrier is preferably in a range of 4 to 6 g/cm³. When the specific weight of the carrier is 4 g/cm³ or more, a sufficient magnetic force due to a magnetic flux in a developing sleeve can be obtained. When the specific weight of the carrier is 6 g/cm³ or less, the toner is less likely to be crushed by the carrier.

The volume average particle size of the carrier is preferably within a range of 20 to 40 μm. When the volume average particle size of the carrier is 20 μm or more, a sufficient magnetic force due to the magnetic flux in the developing sleeve can be obtained. When the volume average particle size of the carrier is 40 μm or less, the toner is less likely to be crushed by the carrier.

### [4. Image Forming Method]

An image forming method according to the present disclosure uses a developer containing a toner, and the toner contains the polyester resin composition according to the present disclosure.

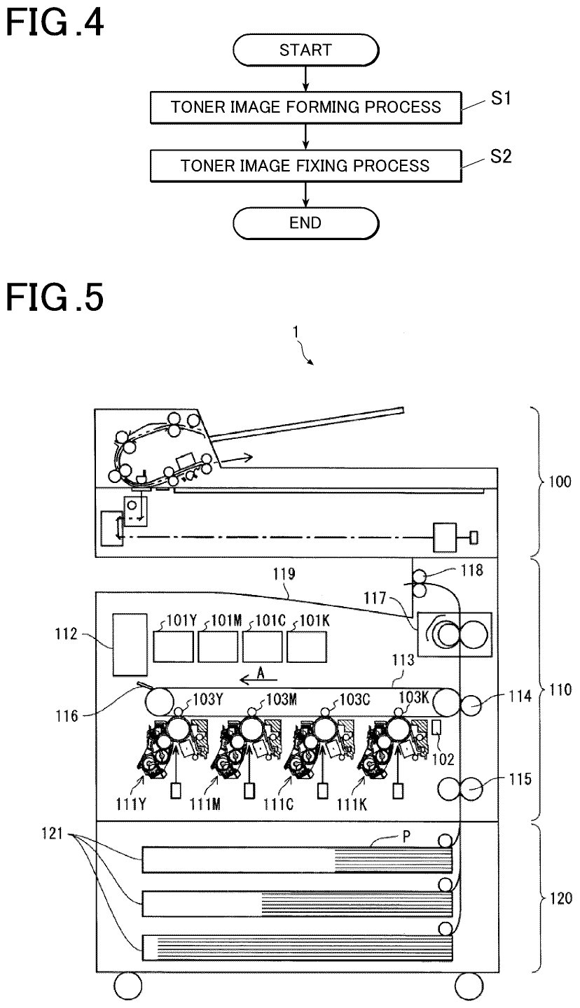

FIG. 4 is an example of a flowchart of the image forming method. The image forming method according to the present disclosure includes, for example, as illustrated in FIG. 4, a toner image forming process S1 and a toner image fixing process S2. In the toner image forming process S1, a toner image is formed on a recording medium. In the toner image fixing process S2, the formed toner image is fixed on the recording medium.

FIG. 5 is a schematic view illustrating an image forming apparatus 1 which can be used in the image forming method. The image forming apparatus 1 illustrated in FIG. 5 includes a document reading section 100, an image forming section 110, and a sheet feed section 120.

The document reading section 100 conveys a document placed on a document plate with an automatic document feeder (ADF) and optically reads the document to generate image data. The image data is stored in a controller 112.

The image forming section 110 includes image forming units 111Y to 111K, a controller 112, an intermediate transfer belt 113, a secondary transfer roller pair 114, a timing roller pair 115, a cleaner 116, a fixing section 117, a sheet ejection roller pair 118, a sheet ejection tray 119, a density sensor 102, and primary transfer rollers 103Y to 103K. Toner cartridges 101Y to 101K of respective colors of Y (yellow), M (magenta), C (cyan), and K (black) are mounted in the image forming section 110.

The image forming units 111Y to 111K receive toner supply from the respective toner cartridges 101Y to 101K and form toner images of Y, M, C, and K colors, respectively, under control of the controller 112. The primary transfer rollers 103Y to 103K electrostatically transfer (primarily transfer) these toner images to the intermediate transfer belt 113 so that the toner images overlap each other. The intermediate transfer belt 113 is an endless rotating body, rotates in the direction of arrow A, and conveys the primarily transferred toner images to a secondary transfer position. As a material of the intermediate transfer belt 113, for example, a semiconductive material in which carbon is dispersed using polycarbonate, polytetrafluoroethylene (PTFE), or polyimide as a main material can be used.

The sheet feed section 120 includes a sheet feed cassette 121 that stores a recording medium P for each sheet size. The sheet feed section 120 supplies the recording medium P to the image forming section 110 one sheet at a time. The supplied recording medium P is conveyed to a secondary transfer roller pair 114 via a timing roller pair 115 while the intermediate transfer belt 113 conveys the toner images.

The timing roller pair 115 includes a pair of rollers. The timing roller pair 115 adjusts timing at which the recording medium P reaches the secondary transfer roller pair 114.

The secondary transfer roller pair 114 includes a pair of rollers to which a transfer voltage is applied. The secondary transfer roller pair 114 is pressed against each other to form a transfer nip portion. At the transfer nip portion, the toner images on the intermediate transfer belt 113 are electrostatically transferred (secondarily transferred) to the recording medium P. The recording medium P with the transferred toner images is conveyed to the fixing section 117. After the secondary transfer, the residual toner remaining on the intermediate transfer belt 113 is further conveyed in the direction of arrow A and then scraped off by the cleaner 116 to be discarded.

The fixing section 117 melts the toner images carried on the recording medium P by heating and presses the toner images onto the recording medium P. The recording medium P on which the toner images have been fused is ejected onto the sheet ejection tray 119 by the sheet ejection roller pair 118.

The controller 112 controls the operation of the image forming apparatus 1. The controller 112 also transmits and receives image data to and from another device such as a personal computer and receives a print job.

The image forming apparatus 1 may perform image stabilization processing in order to stabilize the quality of an image to be formed. The density sensor 102 is a reflective density sensor that illuminates an object to measure density based on the amount of reflected light and optically detects a test pattern formed on the intermediate transfer belt 113 during the image stabilization processing.

Instead of the transfer rollers, a transfer charger or a transfer belt may be used. Instead of the cleaner 116 (cleaning blade), a cleaning brush, a cleaning roller, or the like may be used. Also, for the fixing section 117, instead of the electromagnetic induction heating method, a halogen lamp, a resistance heating element, or the like may be used as a heat source. A fixing heating body may have a roller shape or a belt shape.

Next, a configuration of the image forming units 111Y to 111K will be described, particularly focusing on a developing means. Note that the image forming units 111Y to 111K have the same configuration, and therefore, hereinafter, they are simply referred to as 111, omitting the letters Y, M, C, and K representing the toner colors.

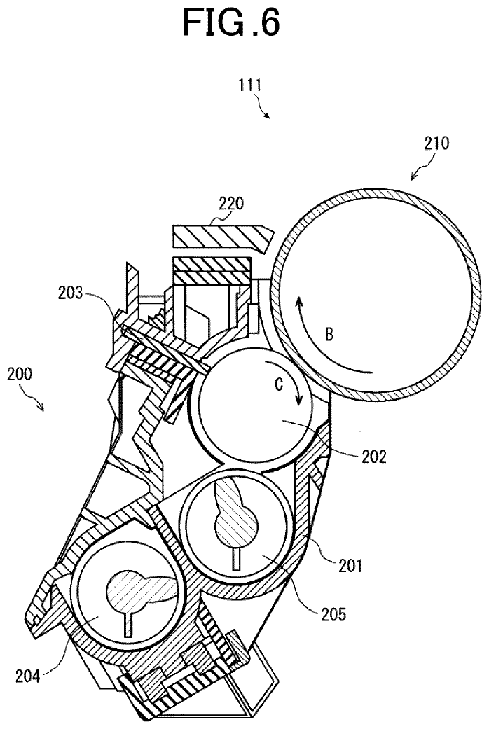

FIG. 6 is a cross-sectional view of a portion of the image forming unit 111. The image forming unit 111 includes a photosensitive drum 210, and a charging means, an exposure means, a developing means 200, and a cleaning means that are sequentially disposed along an outer peripheral surface of the photosensitive drum 210. Among them, the photosensitive drum 210 and the developing means 200 are illustrated in FIG. 6.

The photosensitive drum 210 is rotationally driven by a drive means (not shown) and rotates in the direction of arrow B. The photosensitive drum 210 is, for example, a laminated photoreceptor in which an undercoat layer, a charge generation layer, a charge transport layer, and an overcoat layer are sequentially laminated on an outer peripheral surface of an aluminum tube. The thickness of the charge transport layer is, for example, about 25 μm. The thickness of the overcoat layer is, for example, 2 to 3 μm. The outer peripheral surface of the photosensitive drum 210 is uniformly charged by the charging means and then irradiated with laser light by the exposure means, so that an electrostatic charge image is formed.

The developing means 200 includes a developing housing 201 that opens toward the photosensitive drum 210. A developing roller 202 is disposed in this opening portion. Further, at one edge portion of the opening portion, a regulating blade 203 for regulating a layer thickness of a developer carried on an outer peripheral surface of the developing roller 202 is disposed.

The developing roller 202 has a structure in which a fixedly disposed magnet roller is enclosed in a rotatable sleeve roller. The developing roller 202 rotates, for example, in a counter direction (the direction of arrow C) with respect to the photosensitive drum 210.

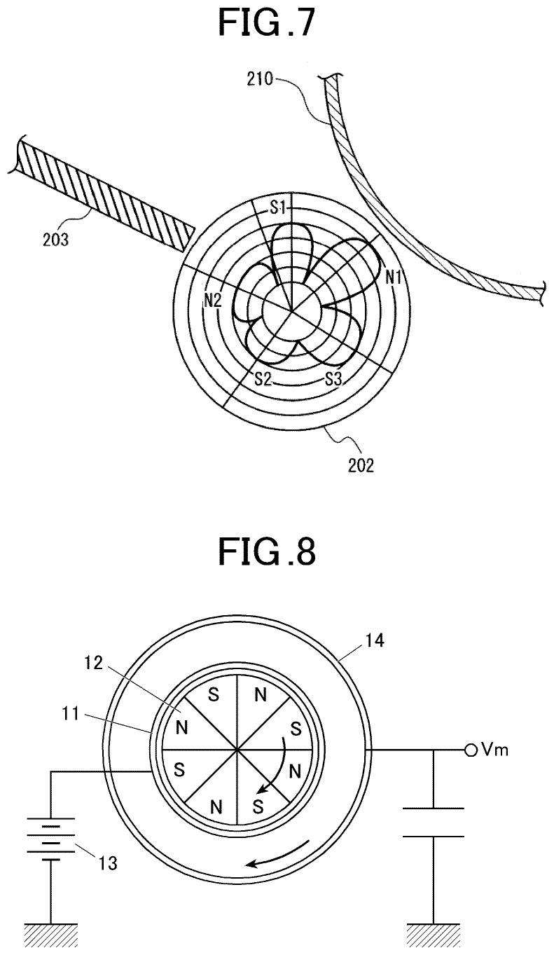

FIG. 7 is a cross-sectional view illustrating a magnetic pole arrangement in the magnet roller included in the developing roller 202. The magnetic roller illustrated in FIG. 7 has five magnetic poles of N1, S1, N2, S2, and S3 in this order along the circumferential direction. Among these five magnetic poles, a developing magnetic pole N1 is disposed at a position facing the photosensitive drum 210.

A conveying magnetic pole S1 and repulsive magnetic poles S2 and S3 are disposed downstream of the developing magnetic pole N1. A regulating magnetic pole N2 is disposed at a position facing the regulating blade 203. The repulsive magnetic poles S2 and S3 generate a repulsive magnetic field for peeling off a developer on the sleeve roller. In particular, the magnetic pole S3 also functions as a pickup magnetic pole.

The developing means 200 receives supply of a developer from the toner cartridge 101 via a toner hopper (unillustrated). The supplied developer is stirred by a stirring screw 204 and a supplying screw 205 to be given a predetermined charge. Then the developer is guided onto the outer peripheral surface of the developing roller 202 by the action of the conveying (supplying) magnetic pole S1 of the developing roller 202.

The developer carried on the outer peripheral surface of the developing roller 202 is conveyed in the direction of arrow C by the rotation of the developing roller 202 and the action of the magnetic field between the conveying magnetic pole S1 and the regulating magnetic pole N2. On the outer peripheral surface of the developing roller 202, the layer thickness of the developer is regulated to a predetermined layer thickness by the regulating blade 203, and then the developer is conveyed to a developing region where the photosensitive drum 210 and the developing roller 202 face each other. The regulating blade 203 regulates the napping height of the developer to prevent fogging and scattering of the toner.

The circumferential speed of the developing roller 202 is not particularly limited, but is preferably in a range of 200 to 800 mm/s. When the circumferential speed of the developing roller 202 increases, the toner tends to be crushed, and therefore, the circumferential speed is preferably 800 mm/s. On the other hand, the toner according to the present disclosure has high crushing resistance and therefore is less likely to be crushed even when the circumferential speed of the developing roller 202 is 200 mm/s or more.

A DC bias is applied to the developing roller 202 from a power source (not shown) as a developing bias. Due to the developing bias, an electrostatic attraction acts between the developing roller 202 and the photosensitive drum 210 in the developing region. As a result, the toner in the developer is supplied from the developing roller 202 to the outer peripheral surface of the photosensitive drum 210, and the electrostatic charge image is visualized.

The developer that has passed through the developing region is further conveyed on the outer peripheral surface of the developing roller 202 in the direction of arrow C. Thereafter, the developer is peeled off the developing roller 202 by the action of the repulsive magnetic poles S2 and S3 to be returned toward the supplying screw 205. The regulating blade 203 is made of, for example, a magnetic material. Therefore, the regulating blade 203 can form an effective nap of the developer between the regulating magnetic pole N2 of the developing roller 202 and the regulating blade 203 and stably regulate the layer thickness.

A toner density sensor 220 is disposed along the outer peripheral surface of the photosensitive drum 210 immediately downstream of the developing region in the rotational direction (direction of arrow B) of the photosensitive drum 201. The toner density sensor 220 detects the density of the toner image formed on the outer peripheral surface of the photosensitive drum 201.

The outer peripheral surface of the photosensitive drum 210 is in contact with the intermediate transfer belt 113 pressed by the primary transfer roller 103. The toner image formed on the outer peripheral surface of the photosensitive drum 210 is transferred to the intermediate transfer belt 113 by a transfer electric field formed by a primary transfer bias applied to the primary transfer roller 103.

By bringing a cleaning blade into contact with the outer peripheral surface of the photosensitive drum 210, the cleaning means mechanically scrapes off and cleans the remaining toner on the outer peripheral surface of the photosensitive drum 210 after the primary transfer. The scraped toner is discharged as waste toner by a screw.

An eraser lamp exposes the outer peripheral surface of the photosensitive drum 210 from which the residual toner has been cleaned, through a gap between the cleaning blade and the charging means. This discharges the outer peripheral surface of the photosensitive drum 210 to a uniform potential of, for example, about −30 V.

Thereafter, by repeating the above-described operation, image formation is executed one after another.

A photosensitive belt may be used in place of the photosensitive drum 210.

The charging means provides a uniform potential to the photosensitive drum 210. The charging method may be a corona discharge method, a roller charging method, or a charging method using a charging blade, a charging brush, a proximity charging member, or the like.

The exposure means performs exposure, based on an image signal, on the photosensitive drum 210 to which the potential has been applied by the charging means to form an electrostatic charge image. As the exposure means, for example, an exposure means that includes an LED in which light emitting elements are arranged in an array in the axial direction of the photosensitive drum 210 and an imaging element, or a laser optical system is used.

The cleaning unit may be a brush, a roller, or the like instead of the cleaning blade. The residual toner may be collected using the developing means 200.

Although embodiments of the present invention have been described and illustrated in detail, the disclosed embodiments are for purposes of illustration and example only and are not intended to be limiting. The scope of the present invention is to be interpreted by the description of the claims.

### EXAMPLES

Hereinafter, the present disclosure will be specifically described with reference to Examples, but the present invention is not limited thereto. In the following Examples, operations were performed in a standard environment of 25° C. and 50% RH unless otherwise specified. In addition, unless otherwise specified, “%,” “ppm,” and “part (s)” mean “% by mass,” “ppm by mass,” and “part (s) by mass,” respectively.

[Preparation of Amorphous Polyester Resin Composition a1]

The following monomers were charged into a reaction vessel equipped with a stirrer, a thermometer, a condenser and a nitrogen gas inlet tube, and the atmosphere in the reaction vessel was replaced with dry nitrogen gas.

### <Monomers>

Neopentyl glycol: 624 parts by mass
Ethylene glycol: 248 parts by mass
Terephthalic acid: 1245 parts by mass
Trimellitic anhydride: 480 parts by mass

The following metal element additives were charged into the reaction vessel.

### <Metal Element Additives>

Boric acid: 1 part by mass
Basic aluminum acetate: 9 parts by mass
Irganox 1222: 18 parts by mass

Irganox 1222 Is diethyl 3,5-di-tert-butyl-4-hydroxybenzylphosphonate (phosphorus-containing compound) manufactured by BASF Japan Ltd.

Under a nitrogen gas airflow, the temperature in the reaction vessel was raised to 235° C. over one hour, and the mixture was reacted for three hours. The pressure in the reaction vessel was reduced to 10.0 mmHg, the mixture was stirred and reacted, and the reaction was terminated when the product reached a desired molecular weight. Thus, an amorphous polyester composition a1 was obtained.

[Preparation of Amorphous Polyester Compositions a2 and a3]

In the preparation of the amorphous polyester composition a1, the types and addition amounts of the monomers and the metal element additives were changed as listed in Table I to prepare each of amorphous polyester compositions a2 and a3.

[Preparation of Crystalline Polyester Composition c1]

The following monomers were charged into a reaction vessel equipped with a stirrer, a thermometer, a condenser and a nitrogen gas inlet tube, and the atmosphere in the reaction vessel was replaced with dry nitrogen gas. Thereafter, tin dioctanoate was added in an amount of 0.3 parts by mass relative to 100 parts by mass of the total amount of the monomers.

### <Monomers>

Ethylene glycol: 621 parts by mass
Tetradodecanedioic acid: 1312 parts by mass
Stearic acid: 1562 parts by mass

The following metal element additives were charged into the reaction vessel.

### <Metal Element Additives>

Basic aluminum acetate: 37 parts by mass
Irganox 1222: 86 parts by mass

Under a nitrogen gas airflow, the mixture was stirred and reacted at 160° C. for three hours, and then the temperature was further increased to 180° C. over 1.5 hours. The pressure in the reaction vessel was reduced to 3 kPa, and the reaction was terminated when the product reached a desired molecular weight. Thus, a crystalline polyester resin composition c1 was obtained.

[Preparation of Crystalline Polyester Resin Composition c2]

In the preparation of the crystalline polyester resin composition c1, the types and the addition amounts of the monomers and the metal element additives were changed as listed in Table 1 to prepare a crystalline polyester resin composition c2.

### Preparation of Amorphous Polyester Resin Composition Ha1 (Comparative Example)

The following monomers were charged into a reaction vessel equipped with a stirrer, a thermometer, a condenser and a nitrogen gas inlet tube, and the atmosphere in the reaction vessel was replaced with dry nitrogen gas.

### <Monomers>

BPA-PO: 3514 parts by mass
BPA-EO: 1296 parts by mass
Terephthalic acid: 664 parts by mass
Trimellitic anhydride: 1152 parts by mass

“BPA-PO” means bisphenol A propylene oxide. “BPA-EO” means bisphenol A ethylene oxide.

The following metal element additives were charged into the reaction vessel.

### <Metal Element Additives>

Boric acid: 1 part by mass
Basic aluminum acetate: 9 parts by mass
Irganox 1222: 18 parts by mass

Under a nitrogen gas airflow, the temperature in the reaction vessel was raised to 235° C. over one hour, and the mixture was reacted for three hours. The pressure in the reaction vessel was reduced to 10.0 mmHg, the mixture was stirred and reacted, and the reaction was terminated when the product reached a desired molecular weight. Thus, an amorphous polyester composition Ha1 (Comparative Example) was obtained.

### Preparation of Amorphous Polyester Resin Composition Ha2 (Comparative Example)

The following components were charged into an autoclave reactor equipped with a thermometer and a stirrer.
Polypropylene glycol: 100 parts by mass
L-lactide: 500 parts by mass
Titanium terephthalate: 1 part by mass

After the atmosphere in the autoclave reactor was replaced with nitrogen, the mixture was reacted at 160° C. for six hours. Thus, an amorphous polyester composition Ha2 (Comparative Example) was obtained.

TABLE I

| | | a1 | a2 | a3 | c1 | c2 | Ha1 | Ha2 |
|---|---|---|---|---|---|---|---|---|
| MONOMERS | NEOPENTYL GLYCOL | 624 | 416 | 988 | — | — | — | — |
| [PARTS | ETHYLENE GLYCOL | 248 | 373 | — | 621 | — | — | — |
| BY MASS] | 1,4-BUTANEDIOL | — | — | — | — | 901 | — | — |
| | BPA-PO | — | — | — | — | — | 3514 | — |
| | BPA-EO | — | — | 216 | — | — | 1296 | — |
| | POLYPROPYLENE | — | — | — | — | — | — | 100 |
| | GLYCOL | | | | | | | |
| | TERAPHTHALIC ACID | 1245 | — | 830 | — | — | 664 | — |
| | FUMARIC ACID | — | 1361 | — | — | — | — | — |
| | ANHYDROUS | 480 | 346 | — | — | — | 1152 | — |
| | TRIMETHYL ACID | | | | | | | |
| | DODECANEDIOIC | — | — | — | — | 1079 | — | — |
| | ACID | | | | | | | |
| | TETRADECANEDIOIC | — | — | — | 1312 | — | — | — |
| | ACID | | | | | | | |
| | STEARIC ACID | — | — | — | 1562 | 1529 | — | — |
| | ADIPIC ACID | — | — | 730 | — | — | — | — |
| | L-LACTIDE | — | — | — | — | — | — | 500 |
| METAL | BORIC ACID | 1 | 7 | — | — | 8 | 1 | — |
| ELEMENT | BASIC ALUMINUM | 9 | 24 | 61 | 37 | 37 | 9 | — |
| ADDITIVES | ACETATE | | | | | | | |
| [PARTS | Irganox1222 | 18 | 53 | 203 | 86 | 89 | 18 | — |
| BY MASS] | TITANIUM | — | — | — | — | — | — | 1 |
| | TEREPHTHALATE | | | | | | | |

| REMARKS | PRESENT | PRESENT | PRESENT | PRESENT | PRESENT | COMPAR- | COMPAR- |
|---|---|---|---|---|---|---|---|
| | INVEN- | INVEN- | INVEN- | INVEN- | INVEN- | ATIVE | ATIVE |
| | TION | TION | TION | TION | TION | EXAMPLE | EXAMPLE |

### [Pyrolysis Gas Chromatography Mass Spectrometry]

The polyester resin compositions produced above were subjected to pyrolysis gas chromatography mass spectrometry under the following conditions.

### <Pyrolysis Conditions>

Pyrolysis reactor: EGA/PY-3030D manufactured by Frontier Laboratories Ltd.
Pyrolysis time: 20 sec
Pyrolysis temperature: 600° C.

### <GC Conditions>

Gas chromatography: TRACE 1310 manufactured by Thermo Fisher Scientific Co., Ltd.
Analysis column: Ultra ALLOY-5 (MS/H T) manufactured by Frontier Laboratories Ltd. (column length: m, internal diameter: 0.25 mm, film thickness: 0.25 μm)
Initial temperature: 45° C. (0 min)
Final temperature: 320° C. (10.5 min)
Inlet conditions: Injection mode—Split method
Carrier gas: helium

The retention time of 4,4′-dihydroxybiphenyl alone was measured in advance, and the initial temperature and the final temperature were set such that the retention time of 4,4′-dihydroxybiphenyl alone was 25 min to 30 min.

### <MS Conditions>

Mass spectrometer: Exactive manufactured by Thermo Fisher Scientific Co., Ltd.

### <GC Conditions>

Ionization method: electron ionization method
Detection conditions: scan
Scan range: m/z 50-750
Sample preparation: sample weighed into a measuring cup to be about 0.1 mg or less Data processing method: proportion of the height of each peak when the sum of the heights of the highest points of respective peaks with respect to the baseline is defined as 100% in total ion current (TIC)

A chromatogram of each polyester resin composition was obtained by pyrolysis gas chromatography mass spectrometry under the above-described conditions. Among the top 20 peaks in relative abundance in the chromatogram, the total number of peaks having a retention time shorter than or equal to the retention time of 4,4′-dihydroxybiphenyl in the chromatogram was counted. The total number was as shown in Table II.

### [Measurement of Metal Element Content]

The polyester resin composition [3 parts by mass] was added to and dispersed in 0.2% by mass aqueous solution of polyoxyethylphenyl ether [35 parts by mass]. This dispersion liquid was treated at 25° C. for five minutes by an ultrasonic homogenizer US-1200T (manufactured by Nissei Corporation) to obtain a measurement sample.
Acid decomposition: emission lines of the measurement sample were obtained by inductively coupled plasma-optical emission spectrometry (ICP-OES).

The contents of boron, aluminum, phosphorus, and titanium in each polyester resin composition were determined from the emission lines and a calibration curve. The calibration curve was prepared in advance by measuring the intensity values for a plurality of known amounts of standard samples of the elements from smaller amounts. Each content [ppm by mass] is relative to 100% by mass of the polyester resin content. The contents were as shown in Table II.

### [Measurement of Acid Value and Hydroxyl Value]

The acid value of the polyester resin in each polyester resin composition was measured according to the method of JIS K 0070:1992. However, only the measurement solvent was changed from the mixed solvent of ethanol and ether specified in JIS K 0070. In the measurement of the amorphous polyester resin, the solvent was changed to a mixed solvent of acetone and toluene (acetone:toluene=1:1 (volume ratio)). In the measurement of the crystalline polyester resin, the solvent was changed to a mixed solvent of chloroform and dimethylformamide (chloroform:dimethylformamide=7:3 (volume ratio)).

The hydroxyl value of the polyester resin in each polyester resin composition was measured according to the method of JIS K 0070:1992. However, only the measurement solvent was changed from the mixed medium of ethanol and ether specified in JIS K 0070 to tetrahydrofuran.

The measured acid value, hydroxyl value and the total value thereof were as shown in Table II.

### [Measurement of Weight Average Molecular Weight Mw]

For the measurement of the weight average molecular weight Mw, an apparatus in which the following had been coupled to each other was used.
Gel permeation chromatography “HLC-8320GPC” (manufactured by Tosoh Corporation), one column “TSKgel guardcolumn SuperHZ-L” (manufactured by Tosoh Corporation)
Three columns “TSKgel SuperHZM-M” (manufactured by Tosoh Corporation)

The columns were stabilized at 40° C., and tetrahydrofuran (THF) as a carrier solvent was flowed through the columns at the same temperature at a flow rate of 0.35 mL/min. A THF sample solution of the measurement sample (resin composition) adjusted to have a sample concentration of 1 mg/mL was treated using a roll mill at room temperature for 10 minutes. The solution was treated with a membrane filter having a pore size of 0.2 μm to obtain a sample solution. The sample solution (10 μL) was injected into the apparatus together with the carrier solvent, and the measurement was performed using a refractive index detector (RI detector).

A calibration curve was prepared using polystyrene standard samples having a monodisperse molecular weight distribution. Based on the calibration curve, the molecular weight distribution of the measurement sample was calculated. The calibration curve was prepared by using 10 samples of “Polystyrene Standard Sample TSK Standard” manufactured by Tosoh Corporation: “A-500”, “F-1”, “F-10”, “F-80”, “F-380”, “A-2500”, “F-4”, “F-40”, “F-128”, and “F-700”. The data collection interval in the sample analysis was set to 300 ms.

The measured weight average molecular weight Mw was as shown in Table II.

### [Measurement of Glass Transition Point Tg]

Differential scanning calorimetry (DSC measurement) was performed using a differential scanning calorimeter “DSC7000X” (manufactured by Hitachi, Ltd.) and a thermal analyzer controller “AS3/DX” (manufactured by Hitachi, Ltd.) to measure the glass transition point. To be specific, 5 mg of a sample was sealed in a sample container having cp6.8 and H2.5 mm (manufactured by Hitachi, Ltd.) for an A1 autosampler and a cover for an A1 autosampler (manufactured by Hitachi, Ltd.).

This was placed in a sample holder of the “AS3/DX”, and the temperature was changed in the order of temperature increase, temperature decrease, and temperature increase. In the first and second temperature increases, the temperature was increased from 0° C. to 150° C. at a temperature increase rate of 10° C./min, and 150° C. was held for one minute. In the temperature decrease, the temperature was decreased from 150° C. to 0° C. at a temperature decrease rate of 10° C./min, and the temperature was held at 0° C. for one minute. A baseline shift in the measurement curve obtained from the second heating was determined. The intersection of an extended line of the baseline before the shift and a tangent line indicating the maximum inclination of the shifted portion of the baseline was defined as the glass transition point Tg. An empty aluminum pan was used as a reference.

The glass transition point Tg was measured only for the amorphous polyester resin composition. The measured glass transition temperature Tg was as shown in Table II.

### [Measurement of Melting Point Tm]

Differential scanning calorimetry (DSC measurement) was performed using a differential scanning calorimeter “DSC7000X” (manufactured by Hitachi, Ltd.) and a thermal analyzer controller “AS3/DX” (manufactured by Hitachi, Ltd.) to measure the melting point. To be specific, 5 mg of a sample was sealed in a sample container having φ6.8 and H2.5 mm (manufactured by Hitachi, Ltd.) for an A1 autosampler and a cover for an A1 autosampler (manufactured by Hitachi, Ltd.). This was placed in a sample holder of the “AS3/DX”, and the temperature was changed in the order of temperature increase, temperature decrease, and temperature increase. In the first and second temperature increases, the temperature was increased from 0° C. to 150° C. at a temperature increase rate of 10° C./min, and 150° C. was held for one minute. In the temperature decrease, the temperature was decreased from 150° C. to 0° C. at a temperature decrease rate of 10° C./min, and the temperature was held at 0° C. for one minute. The temperature at the top of the endothermic peak in the endothermic curve obtained during the second heating was taken as the melting point Tm. An empty aluminum pan was used as a reference.

The melting point Tm was measured only for the crystalline polyester resin composition. The measured melting point Tm was as shown in Table IL.

TABLE II

| | a1 | a2 | a3 | c1 | c2 | Ha1 | Ha2 |
|---|---|---|---|---|---|---|---|
| NUMBER OF PEAKS: N | 14 | 6 | 1 | 16 | 17 | 0 | 18 |
| B CONTENT [ppm] | 15 | 98 | 0 | 0 | 852 | 13 | — |
| Al CONTENT [ppm] | 28 | 51 | 359 | 931 | 752 | 31 | — |
| P CONTENT [ppm] | 52 | 167 | 2420 | 1893 | 1651 | 55 | — |
| Ti CONTENT [ppm] | — | — | — | — | — | — | 325 |
| (B + Al + P) | 95 | 316 | 2779 | 2824 | 3255 | 99 | 0 |
| CONTENT [ppm] | | | | | | | |
| ACID VALUE [mg KOH/g] | 15 | 82 | 127 | 421 | 565 | 12 | 121 |
| HYDROXYL VALUE | 25 | 76 | 89 | 332 | 489 | 18 | 118 |
| [mg KOH/g] | | | | | | | |
| ACID VALUE + | 40 | 158 | 216 | 753 | 1054 | 30 | 239 |
| HYDROXYL VALUE | | | | | | | |
| [mg KOH/g] | | | | | | | |
| WEIGHT AVERAGE | 13300 | 11500 | 14200 | 4200 | 3200 | 14200 | 11100 |
| MOLECULAR WEIGHT Mw | | | | | | | |
| GLASS TRANSITION POINT Tg | 57.7 | 57.8 | 61.2 | — | — | 58.7 | 56.9 |
| [° C.] | | | | | | | |
| MELTING POINT | — | — | — | 50.8 | 49.7 | — | — |
| Tm [° C.] | | | | | | | |
| REMARKS | PRESENT | PRESENT | PRESENT | PRESENT | PRESENT | COMPAR- | COMPAR- |
| | INVEN- | INVEN- | INVEN- | INVEN- | INVEN- | ATIVE | ATIVE |
| | TION | TION | TION | TION | TION | EXAMPLE | EXAMPLE |

### [Preparation of Amorphous Polyester Resin Dispersion A1]

The following components were charged into a reaction vessel equipped with a stirrer and dissolved at 60° C.
Amorphous polyester resin composition a1: 100 parts by mass
Methyl ethyl ketone: 60 parts by mass
Isopropyl alcohol: 10 parts by mass

After confirmation of dissolution, the reaction vessel was cooled to 35° C., and then a 10% aqueous ammonia solution [3.5 parts by mass] was added thereto. Next, ion-exchanged water (300 parts by mass) was added dropwise to the reaction vessel over three hours to prepare a polyester resin dispersion. Then, the methyl ethyl ketone and the isopropyl alcohol were removed by an evaporator to obtain an amorphous polyester dispersion A1.

### [Preparation of Amorphous Polyester Resin Dispersion A2]

An amorphous polyester resin dispersion A2 was prepared by changing the amorphous polyester resin composition a1 to the amorphous polyester resin composition a2 in the preparation of the amorphous polyester resin dispersion A1.

### [Preparation of Amorphous Polyester Resin Dispersion A3]

An amorphous polyester resin dispersion A3 was prepared by changing the amorphous polyester resin composition a1 to the amorphous polyester resin composition a3 in the preparation of the amorphous polyester resin dispersion A1.

### [Preparation of Crystalline Polyester Resin Dispersion C1]

A crystalline polyester resin dispersion C1 was prepared by changing the amorphous polyester resin composition a1 to the crystalline polyester resin composition c1 in the preparation of the amorphous polyester resin dispersion A1.

### [Preparation of Crystalline Polyester Resin Dispersion C2]

A crystalline polyester resin dispersion C2 was prepared by changing the amorphous polyester resin composition a1 to the crystalline polyester resin composition c2 in the preparation of the amorphous polyester resin dispersion A1.

### [Preparation of Amorphous Polyester Resin Dispersion HA1]

An amorphous polyester resin dispersion HA1 was prepared by changing the amorphous polyester resin composition a1 to the amorphous polyester resin composition Ha1 in the preparation of the amorphous polyester resin dispersion A1.

### [Preparation of Amorphous Polyester Resin Dispersion HA2]

An amorphous polyester resin dispersion HA2 was prepared by changing the amorphous polyester resin composition a1 to the amorphous polyester resin composition Ha2 in the preparation of the amorphous polyester resin dispersion A1.

### [Preparation of Vinyl Resin Dispersion V1]

### (a) First Stage Polymerization

Sodium dodecyl sulfate [8 parts by mass] and ion-exchanged water [3000 parts by mass] were charged into a 5-L reaction vessel equipped with a stirrer, a temperature sensor, a cooling tube, and a nitrogen introduction device. The internal temperature was raised to 80° C. while stirring the mixture at a rate of 230 rpm under a nitrogen airflow. After the temperature rise, a solution obtained by dissolving potassium persulfate [10 parts by mass] in ion-exchanged water [200 parts by mass] was added thereto, and the liquid temperature was adjusted to 80° C. again. A mixture of the following monomers was added dropwise thereto over one hour.
n-butyl acrylate: 526 parts by mass
Methacrylic acid: 474 parts by mass

After the dropwise addition, polymerization was carried out by heating and stirring the mixture at 80° C. for two hours to prepare a vinyl resin particle dispersion dl.

### (b) Second Stage Polymerization

Sodium dodecyl sulfate [7 parts by mass] and ion-exchanged water [3000 parts by mass] were charged into a 5-L reaction vessel equipped with a stirrer, a temperature sensor, a cooling tube, and a nitrogen introduction device, and the mixture was heated to 98° C. Thereafter, the vinyl resin particle dispersion dl [300 parts by mass (in terms of solid content)] prepared by the first stage polymerization and a mixed solution in which the following components were dissolved at 90° C. were added to the reaction vessel.
2-ethylhexyl acrylate: 90.5 parts by mass
Methacrylic acid: 33.1 parts by mass
n-octyl mercaptan (chain transfer agent): 5.5 parts by mass

A mechanical disperser CLEARMIX (manufactured by M Technique Co., Ltd.) having a circulation path was used to perform a mixing and dispersing treatment for one hour to prepare a dispersion containing emulsified particles (oil droplets). To this dispersion, a polymerization initiator solution obtained by dissolving potassium persulfate [6 parts by mass] in ion-exchanged water [200 parts by mass] was added. The system was heated and stirred at 78° C. for one hour for polymerization to prepare a vinyl resin particle dispersion d2.

### (c) Third Stage Polymerization

To the vinyl resin particle dispersion d2 obtained by the second stage polymerization, ion-exchanged water [400 parts by mass] was further added and mixed well. Thereafter, a polymerization initiator solution in which potassium persulfate [6.0 parts by mass] was dissolved in ion-exchanged water [400 parts by mass] was added to the mixture. Furthermore, under a temperature condition of 81° C., a mixed solution of the following components was added dropwise over 1 hour to the mixture.
n-butyl acrylate: 143.2 parts by mass
Methacrylic acid: 52.0 parts by mass
n-octyl mercaptan (chain transfer agent): 8.0 parts by mass

After completion of the dropwise addition, the mixture was heated and stirred for two hours for polymerization, and then cooled to 28° C.

By the above operation, a vinyl resin dispersion V1 was obtained. The vinyl resin contained in the vinyl resin dispersion V1 is referred to as “vinyl resin V1”. The vinyl resin d1 had a weight average molecular weight of 35000.

### [Preparation of Release Agent Dispersion W1]

The following components were mixed, and the release agent was dissolved at an internal liquid temperature of 120° C. using a pressure discharge homogenizer (Gaulin Homogenizer manufactured by Gaulin). As the anionic surfactant, TAYCAPOWER BN2060 (active ingredient content: 60%) manufactured by Tayca Corporation was used.
Behenyl behenate (release agent): 270 parts by mass
Anionic surfactant: 13.5 parts by mass
Ion-exchanged water: 700 parts by mass

The addition amount of the anionic surfactant in terms of active ingredient was 8.1 parts by mass, which was 3.0% by mass relative to the addition amount of the release agent. After the dissolution, the mixture was dispersed at a dispersion pressure of 5 MPa for 120 minutes and subsequently at 40 MPa for 360 minutes and cooled. The volume average particle size D50v of the particles contained in the obtained dispersion was 220 nm. Thereafter, ion-exchanged water was added to the dispersion to adjust the solid content concentration to 20.0% by mass. Thus, a release agent dispersion W1 was obtained.

### [Preparation of Black Colorant Dispersion P1]

REGAL 330 (manufactured by Cabot Corporation, carbon black, pigment) was used as a black colorant. NEOGEN SC (manufactured by DKS Co., Ltd., active ingredient: 60%) was used as an anionic surfactant. As a container, a stainless steel container was used, which is sized so that the height of the liquid level becomes one third of the height of the container when ion-exchanged water [750 parts by mass], an anionic surfactant [33 parts by mass] and a black colorant [200 parts by mass] are charged thereto.

Ion-exchanged water (280 parts by mass) and the anionic surfactant (33 parts by mass) were placed in the container to sufficiently dissolve the surfactant. Thereafter, the black colorant [200 parts by mass] was added thereto, and the mixture was stirred with a stirrer until no non-wetted black colorant remained. Thereafter, ion-exchanged water (470 parts by mass) was added thereto, and the mixture was further stirred to be sufficiently defoamed. The addition amount of the anionic surfactant in terms of active ingredient was 20 parts by mass, which was 10% by mass relative to the addition amount of the black colorant.

After the defoaming, the mixture was dispersed with a homogenizer (ULTRA-TURRAX T50 manufactured by Ika-Werke GmbH & Co. KG) at 5000 rpm for 10 minutes, and then stirred with a stirrer for 24 hours to be defoamed. After the defoaming, the mixture was dispersed again at 6000 rpm for 10 minutes using the homogenizer, and then stirred for 24 hours with a stirrer to be defoamed.

After the defoaming, the mixture was dispersed at a pressure of 240 MPa using a high-pressure impact dispersing device ULTIMIZER (HJP30006 manufactured by Sugino Machine Limited). The dispersion was performed for the equivalent of 25 passes when calculated from the total amount charged and the processing capacity of the apparatus.

The resulting dispersion was allowed to stand for 72 hours to remove precipitates, and ion-exchanged water was added thereto to adjust the solid content concentration to 15% to obtain a black colorant dispersion P1. The volume average particle size D50v of the particles contained in the black colorant dispersion P1 was 110 nm.

### [Preparation of Toner A]

### (Preparation of Toner Base Particles)

The following materials were premixed in a Henschel mixer, and then the mixture was melt-kneaded using PCM-30 (manufactured by Ikegai Ironworks Co., Ltd.) while setting the temperature so that the temperature of the melt at the discharge port was 150° C.
Amorphous polyester composition a1: 92 parts by mass
Carbon black: 5 parts by mass
Behenyl behenate (release agent): 3 parts by mass

The resulting kneaded product was cooled, coarsely pulverized with a hammermill, and then finely pulverized using a Turbo Mill T250 (manufactured by Turbo Kogyo Co., Ltd.) as a pulverizer. The obtained finely pulverized powder was classified using a multi-part classifier utilizing the Coanda effect to obtain toner base particles a having a volume average particle size of 6.5 μm.

### (External Additive Processing)

The following components were mixed in a Henschel mixer (manufactured by Nippon Coke & Engineering Co., Ltd.) at a rotor peripheral speed of 40 m/sec and 32° C. for 20 minutes. The hydrophobic silica particles had a number average primary particle size of 12 nm and a hydrophobicity degree of 68. The sol-gel silica particles had a number average primary particle size of 110 nm.
Toner base particles a: 100.0 parts by mass
Hydrophobic silica particles (external additive): 1.0 parts by mass
Sol-gel silica particles (external additive): 1.0 parts by mass

After the mixing, coarse particles were removed with a sieve having an opening of 45 μm to obtain toner A.

### [Preparation of Toner B]

### (Preparation of Toner Base Particles)

The dispersions prepared above were charged into a round stainless steel flask in the following amounts.
Amorphous polyester resin dispersion A1: 89 parts by mass (solid content equivalent)
Colorant dispersion P1: 6 parts by mass (solid content equivalent)
Release agent dispersion W1: 5 parts by mass (solid content equivalent)

Thereafter, ion-exchanged water was added to the flask so that the solid content concentration of the contents of the flask became 12.5% by mass, and a 10% aqueous solution of aluminum sulfate (6.3 parts by mass) was further added thereto. Next, the mixture was mixed and dispersed using a homogenizer (ULTRA-TURRAX T50 manufactured by Ika-Werke GmbH & Co. KG) at 5000 rpm for 10 minutes. Thereafter, the contents of the flask were heated to 40° C. while being stirred. Then, the temperature was increased by 0.5° C. per minute until the particle size reached 6.1 μm and the temperature was maintained.

Thereafter, 11 parts by mass of ethylenediaminetetraacetic acid (EDTA) tetrasodium salt (Chelest 40 manufactured by Chelest Corporation) was added thereto. Next, an aqueous sodium hydroxide solution was added to adjust the pH of the mixture to 8. Next, after raising the temperature to 82.5° C., the pH was lowered by 0.05 with nitric acid every 10 minutes, and stirring was continued for 45 minutes. After cooling, the mixture was filtered, sufficiently washed with ion-exchanged water, and dried to obtain toner base particles b.

### (External Additive Processing)

The following components were mixed in a Henschel mixer (manufactured by Nippon Coke & Engineering Co., Ltd.) at a rotor peripheral speed of 40 m/sec and 32° C. for 20 minutes. The hydrophobic silica particles had a number average primary particle size of 12 nm and a hydrophobicity degree of 68. The sol-gel silica particles had a number average primary particle size of 110 nm.
Toner base particles b: 100.0 parts by mass
Hydrophobic silica particles (external additive): 1.0 parts by mass
Sol-gel silica particles (external additive): 1.0 parts by mass

After the mixing, coarse particles were removed with a sieve having an opening of 45 μm to obtain toner B.

### [Preparation of Toner C]

### (Preparation of Toner Base Particles)

The following components were charged into a round stainless steel flask.
Vinyl resin dispersion V1: 58 parts by mass (solid content equivalent)
Crystalline polyester resin dispersion C1: 23 parts by mass (solid content equivalent)
Black colorant dispersion P1: 6 parts by mass (solid content equivalent)
Release agent dispersion W1: 5 parts by mass (solid content equivalent)
10% aqueous solution of aluminum sulfate: 63 parts by mass
Ion-exchanged water: 750 parts by mass

Next, the mixture was mixed and dispersed using a homogenizer “ULTRA-TURRAX T50” (manufactured by Ika-Werke GmbH & Co. KG) at 5000 rpm for 10 minutes. Thereafter, the reaction product in the flask was heated to 40° C. while being stirred. Thereafter, the temperature was increased at 0.5° C. per minute, and when the particle size of the reaction product reached 5.5 μm, the temperature was maintained. Thus, core particles were formed.

Next, the following components were added dropwise to the above flask over one hour. As the ethylenediaminetetraacetic acid (EDTA) tetrasodium salt, “Chelest 40” (manufactured by Chelest Corporation) was used.
Amorphous polyester resin dispersion A1: 6 parts by mass (solid content equivalent)
Ethylenediaminetetraacetic acid (EDTA) Tetrasodium salt: 18 parts by mass

Thereafter, an aqueous sodium hydroxide solution was added to adjust the pH of the reaction liquid to 8. Then, after the temperature of the reaction solution was raised to 82.5° C., the pH of the reaction solution was lowered by 0.05 with nitric acid every 10 minutes, and stirring was continued for 45 minutes. Thereafter, the reaction liquid was cooled until the temperature became 40° C. or lower, and the stirring was stopped. Thus, shells were formed.

Thereafter, the aggregates were removed by filtration with a filter having an opening of 45 μm. Then, after the pH of the reaction solution was adjusted to 4 with hydrochloric acid, a water-containing cake (aggregate of toner base particles) was taken out using a centrifugal separator. The water-containing cake was washed with ion-exchanged water in an amount of 10 times the solid content of the toner base particles while being centrifuged. Thereafter, the resulting product was dehydrated for 10 minutes to take out the water-containing cake.

Next, the obtained water-containing cake was supplied to a dryer (Flash Jet Dryer, manufactured by Seishin Co., Ltd.) and subjected to a drying treatment. The conditions of the drying treatment were set such that the airflow temperature was 80° C., the airflow speed was 10 m/sec, and the outlet temperature was 35° C. Thus, core-shell toner base particles c were obtained. The moisture content of the toner base particles c was 1.2 mass % relative to the total mass of the toner base particles.

### (External Additive Processing)

The following components were mixed in a Henschel mixer (manufactured by Nippon Coke & Engineering Co., Ltd.) at a rotor peripheral speed of 40 m/sec and 32° C. for 20 minutes. The hydrophobic silica particles had a number average primary particle size of 12 nm and a hydrophobicity degree of 68. The hydrophobic titanium oxide particles had a number average primary particle size of 20 nm and a hydrophobicity degree of 63. The sol-gel silica particles had a number average primary particle size of 110 nm.
Toner base particles c: 100.0 parts by mass
Hydrophobic silica particles (external additive): 1.0 parts by mass
Hydrophobic titanium oxide particles (external additive): 0.5 parts by mass
Sol-gel silica particles (external additive): 1.0 parts by mass

After the mixing, coarse particles were removed with a sieve having an opening of 45 μm to obtain toner C.

### [Preparation of Toners D to G]

Toners D to G were prepared by changing the type and the addition amount of each resin dispersion as shown in Table III in the preparation of the toner C.

TABLE III

| | CORE PARTICLE FORMATION | | | | SHELL FORMATION | |
|---|---|---|---|---|---|---|
| | | | CRYSTALLINE POLYESTER | | AMORPHOUS POLYESTER | |
| | VINYL RESIN DISPERSION | | RESIN DISPERSION | | RESIN DISPERSION | |
| | | ADDITION AMOUNT | | ADDITION AMOUNT | | ADDITION AMOUNT |
| | | [PARTS BY MASS] | | [PARTS BY MASS] | | [PARTS BY MASS] |
| | | (SOLID CONTENT | | (SOLID CONTENT | | (SOLID CONTENT |
| | TYPE | EQUIVALENT) | TYPE | EQUIVALENT) | TYPE | EQUIVALENT) |
| TONER C | V1 | 58 | C1 | 23 | A1 | 6 |
| TONER D | V1 | 35 | C2 | 46 | A2 | 6 |
| TONER E | V1 | 20 | C1 | 59 | A3 | 8 |
| TONER F | V1 | 14 | C2 | 64 | A1 | 9 |
| TONER G | V1 | 4 | C2 | 72 | A3 | 11 |

### Preparation of Toner H (Comparative Example)

Toner H was prepared by changing the amorphous polyester composition a1 to the amorphous polyester composition Ha1 in the preparation of the toner A.

### Preparation of Toner I (Comparative Example)

Toner I (comparative example) was prepared by changing the amorphous polyester composition a1 to the amorphous polyester composition Ha2 in the preparation of the toner A.

### [Compositions and Physical Properties of Toners A to I]

The type of the resin and the content of the polyester resin composition in each of the toners A to I are as listed in Table IV.

The volume average particle size, the average circularity, and the glass transition point Tg of each of the toners A to I were measured by the above-described methods. The results of these measurements are as described in Table IV.

### [Evaluation of Low-Temperature Fixability of Toners]

For evaluation, a commercially available digital full-color multifunction apparatus “bizhub C650i” (manufactured by Konica Minolta, Inc.) modified so that the surface temperatures of the upper fixing belt and the lower fixing roller can be changed was used. A test in which a solid image having a toner adhesion amount of 11.3 g/m² was output on A4 plain paper (basis weight: 80 g/m²) was repeatedly performed using the toner prepared above while changing the fixing temperature in a range of 100° C. to 200° C. at intervals of 5° C. The nip width was set to 11.2 mm. The fixing time was set to 34 msec. The fixing pressure was set to 133 kPa. The lowest fixing temperature at which image contamination due to fixing offset was not visually observed was defined as the lowest fixing temperature. The low-temperature fixability of each toner was evaluated based on the following criteria. The evaluation results are as listed in Table IV.
A: The lowest fixing temperature is lower than 130° C. (excellent toner having excellent low-temperature fixability).
B: The lowest fixing temperature is 130° C. or higher and lower than 150° C. (toner that is not practically problematic while being controlled by the apparatus).
C: The lowest fixing temperature is 150° C. or higher (toner that is not sufficiently fixed at the target sheet passing speed and is practically problematic).

### [Evaluation of Heat-Resistant Storage Stability of Toner]

The toner [0.5 g] prepared above was placed in a 10 mL glass bottle having an inner diameter of 21 mm, the glass bottle was closed with a cap and shaken 600 times at room temperature with a Tap Denser KYT-2000 (manufactured by Seishin Enterprise Co., Ltd.). Thereafter, the glass bottle with the cap removed was left in an environment of 55° C. and 35% RH for two hours. Next, the toner was placed on a 48-mesh sieve (opening: 350 μm) with care not to disintegrate aggregates of the toner and set in the Powder Tester (manufactured by Hosokawa Micron Corporation). The pressing bar and the knob nut were fixed, the vibration strength was adjusted to a feed width of 1 mm, and the vibration was applied for 10 seconds. Thereafter, the mass (g) of the toner on the sieve was measured. The toner aggregation rate [%] was calculated by the following formula.

$$Toner aggregation rate [ \% ] = toner mass on sieve [ g ] / 0.5 g \times 100$$

The heat-resistant storage stability of each toner was evaluated based on the following criteria. The evaluation results are as listed in Table IV.
A: The toner aggregation rate is less than 5% (toner having excellent heat-resistant storage stability).
B: The toner aggregation rate is 5% or more and less than 15% (toner having satisfactory heat-resistant storage stability and being durable for practical use).
C: The toner aggregation rate is 15% or more (toner having poor heat-resistant storage stability and being not suitable for use).

### [Evaluation of Crushing Resistance of Toner]

The toner [10 g] prepared above, commercially available titanium dioxide fine particles [0.05 g], and commercially available glass beads [30 g] having a diameter of 3 mm were placed in a polyethylene container, and mixed for 10 minutes with a TURBULA mixer. The particle size distribution of the toner before and after the mixing treatment was measured with a Coulter counter (manufactured by Nikkiso Co., Ltd.). The number ratios [%] of toner particles having a particle size of 4 μm or less were determined before and after the mixing treatment. The number ratios [%] before and after the mixing treatment were compared to obtain the amount of increase in the number ratio [%]. The crushing resistance of each toner was evaluated based on the following criteria. A and B are acceptable. The evaluation results are as listed in Table IV.
A: The amount of increase is less than 3.0%.
B: The amount of increase is 3.0% or more and less than 10.0%.
C: The amount of increase is 10.0% or more.

### [Preparation of Developer]

Toluene [14.0 parts by mass], a cyclohexyl methacrylate/dimethylaminoethyl methacrylate copolymer (weight ratio 99:1, Mw: 80000) [2.0 parts by mass], and glass beads (φ1 mm) [14.0 parts by mass] were mixed. The mixture was stirred at 1200 rpm for 30 minutes using a sand mill (manufactured by Kansai Paint Co., Ltd.) to obtain a solution for forming a resin-coated layer. The solution for forming a resin-coated layer and ferrite particles were put into a vacuum degassing kneader, the pressure was reduced, and toluene was distilled off for drying. As the ferrite particles, Mn—Mg—Sr-based ferrite particles having an average particle size of 30 μm were used. Thus, a resin-coated carrier was prepared. The specific weight of the carrier was 5.2 g/cm³. The volume average particle size of the carrier was 33.1 μm.

The toner [100 parts by mass] prepared above and the resin-coated carrier [7 parts by mass] prepared above were charged into a 2-L V-blender and stirred for 20 minutes under a normal temperature and normal humidity environment. Thereafter, the resulting product was sieved at 105 μm to obtain a developer.

Through the above operations, developers containing the respective toners prepared above were prepared.

### [Evaluation of Charge Retention]

Continuous printing was performed using a chart having a printing rate of 2%, and the charge amounts were measured at the start of printing and after printing 10,000 sheets. The image forming apparatus used was “bizhub C650i” (manufactured by Konica Minolta, Inc.). The apparatus includes a developing means for forming a layer of a developer on a developing roller. The circumferential speed of the developing roller of the apparatus is usually 350 mm/sec. However, a modification was made to increase the circumferential speed to 750 mm/sec, and evaluation of the charge retention was performed under these severe conditions. The evaluation was performed using a black position mounted on the apparatus. The measurement of the charge amounts was performed as follows using a device illustrated in FIG. 8. First, a two-component developer [1 g] weighed on a precision balance was placed uniformly on the entire surface of a conductive sleeve 11. A voltage of 2 kV was supplied from a bias power source 13 to the conductive sleeve 11, and the rotation speed of a magnet roller 12 disposed in the conductive sleeve 11 was set to 1000 rpm. The two-component developer was allowed to stand under these conditions for 30 seconds and collected on a cylindrical electrode 14. After 30 seconds, the potential Vm of the cylindrical electrode 14 was read, and the charge amount of the two-component developer was obtained. The mass of the collected two-component developer was measured with a precision balance. The average charge amount [pC/g] was obtained from the charge amount and the mass of the two-component developer. The charge amount at the start of printing and the charge amount after printing 10,000 sheets are as shown in Table IV.

The amount of change in the charge amount was obtained from the following Formula (1).

$$a = \vert ( b - c ) \vert \qquad Formula ( 1 )$$

a: Amount of change in charge amount [μC/g]
b: Charge amount [μC/g] at start of printing
c: Charge amount [μC/g] after printing 10,000 sheets

The charge retention of each toner was evaluated based on the following criteria. A and B are acceptable. The evaluation results are as listed in Table IV.
A: The amount of change in the charge amount is 4 μC/g or less.
B: The amount of change in the charge amount is more than 4 μC/g and 10 μC/g or less.
C: The amount of change in the charge amount is more than 10 μC/g.
   [Evaluation of in-Machine Scattering Resistance]

A double-sided tape was attached to an upper portion of a developing means before the start of printing. A toner contamination component due to toner scattering in the apparatus after printing 10,000 sheets was measured with a reflection densitometer (RD-918 manufactured by Macbeth). The difference between the reflection density at the start of printing and the reflection density after printing of 10,000 sheets was obtained. The in-machine scattering resistance of each toner was evaluated based on the following criteria. The image forming apparatus used was “bizhub C650i” (manufactured by Konica Minolta, Inc.). The apparatus includes a developing means for forming a layer of a developer on a developing roller. The circumferential speed of the developing roller of the device is usually 350 mm/sec. However, the circumferential speed was changed to 250 mm/sec, 500 mm/sec, 750 mm/sec, and 1000 mm/sec for the evaluation. The toners H and I were not evaluated for the circumferential speed of 1000 mm/sec. A and B are acceptable. The evaluation results for each circumferential speed are as shown in Table IV.
A: There is almost no observed increase in density due to toner scattering from the start of printing, and the difference in reflection density is 0.1 or less.
B: Although slight toner scattering is observed from the start of printing, there is no practical problem, and the difference in reflection density is more than 0.1 and 0.8 or less.
C: The amount of toner scattering from the start of printing is large, which is a problem in practical use, and the difference in reflection density is more than 0.8.

TABLE IV

| | | TONER A | TONER B | TONER C | TONER D | TONER E |
|---|---|---|---|---|---|---|
| PRODUCTION METHOD | | KNEADING AND | EMULSION | EMULSION | EMULSION | EMULSION |
| | | PULVERIZING | AGGREGATION | AGGREGATION | AGGREGATION | AGGREGATION |
| AMORPHOUS POLYESTER RESIN | | a1 | a1 | a1 | a2 | a3 |
| COMPOSITION | | | | | | |
| CRYSTALLINE POLYESTER | | — | — | c1 | c2 | c1 |
| RESIN COMPOSITION | | | | | | |
| VINYL RESIN | | — | — | v1 | v1 | v1 |
| POLYESTER RESIN | | 90.2 | 90.2 | 28.5 | 51.7 | 66.7 |
| COMPOSITION CONTENT | | | | | | |
| [MASS %] | | | | | | |
| VOLUME AVERAGE | | 6.5 | 6.6 | 6.6 | 6.4 | 6.5 |
| PARTICLE SIZE | | | | | | |
| [μm] | | | | | | |
| AVERAGE CIRCULARITY | | 0.937 | 0.989 | 0.995 | 0.951 | 0.967 |
| GLASS TRANSITION POINT Tg | | 57.5 | 48.7 | 46.5 | 51.2 | 55.3 |
| [° C.] | | | | | | |
| LOW-TEMPERATURE | | B | B | B | B | A |
| FIXABILITY | | | | | | |
| HEAT-RESISTANT STORAGE | | A | B | B | A | A |
| STABILITY | | | | | | |
| CRUSHING RESISTANCE | | A | A | B | A | A |
| CHARGE | AT START OF | −45.8 | −53.3 | −53.3 | −38.6 | −42.8 |
| AMOMUNT | PRINTING | | | | | |
| [μC/g] | AFTER PRINTING | −46.2 | −49.2 | −49.2 | −37.5 | −46.1 |
| | 10,000 SHEETS | | | | | |
| CHARGE RETENTION | | A | B | B | A | A |
| IN-MACHINE | 250 mm/sec | A | A | A | A | A |
| SCATTERING | 500 mm/sec | A | A | A | A | A |
| RESISTANCE | 750 mm/sec | A | A | B | A | A |
| | 1000 mm/sec | A | A | B | A | A |

| REMARKS | PRESENT | PRESENT | PRESENT | PRESENT | PRESENT |
|---|---|---|---|---|---|
| | INVENTION | INVENTION | INVENTION | INVENTION | INVENTION |

| | | TONER F | TONER G | TONER H | TONER I |
|---|---|---|---|---|---|
| PRODUCTION METHOD | | EMULSION | EMULSION | KNEADING AND | KNEADING AND |
| | | AGGREGATION | AGGREGATION | PULVERIZING | PULVERIZING |
| AMORPHOUS POLYESTER RESIN | | a1 | a3 | Ha1 | Ha2 |
| COMPOSITION | | | | | |
| CRYSTALLINE POLYESTER | | c2 | c2 | — | — |
| RESIN COMPOSITION | | | | | |
| VINYL RESIN | | v1 | v1 | — | — |
| POLYESTER RESIN | | 72.6 | 82.6 | 90.2 | 90.2 |
| COMPOSITION CONTENT | | | | | |
| [MASS %] | | | | | |
| VOLUME AVERAGE | | 6.6 | 6.4 | 6.5 | 6.4 |
| PARTICLE SIZE | | | | | |
| [μm] | | | | | |
| AVERAGE CIRCULARITY | | 0.978 | 0.984 | 0.938 | 0.935 |
| GLASS TRANSITION POINT Tg | | 47.3 | 53.3 | 58.5 | 56.4 |
| [° C.] | | | | | |
| LOW-TEMPERATURE | | A | A | C | B |
| FIXABILITY | | | | | |
| HEAT-RESISTANT STORAGE | | B | A | B | C |
| STABILITY | | | | | |
| CRUSHING RESISTANCE | | A | A | C | C |
| CHARGE | AT START OF | −55.2 | −45.6 | −44.2 | −53.1 |
| AMOMUNT | PRINTING | | | | |
| [μC/g] | AFTER PRINTING | −54.3 | −44.2 | −12.1 | −9.4 |
| | 10,000 SHEETS | | | | |
| CHARGE RETENTION | | A | A | C | C |
| IN-MACHINE | 250 mm/sec | A | A | B | C |
| SCATTERING | 500 mm/sec | A | A | C | C |
| RESISTANCE | 750 mm/sec | A | A | C | C |
| | 1000 mm/sec | A | A | — | — |

| | | | | |
|---|---|---|---|---|
| REMARKS | PRESENT | PRESENT | COMPARATIVE | COMPARATIVE |

| | | | |
|---|---|---|---|
| INVENTION | INVENTION | EXAMPLE | EXAMPLE |

From the above results, it was confirmed that the polyester resin composition according to the present disclosure can improve the low-temperature fixability, the heat-resistant storage stability, and the crushing resistance of the toner.

In addition, it was confirmed that the polyester resin composition according to the present disclosure can also improve the charge retention of the toner. This is due to the fact that the polyester resin composition according to the present disclosure has improved the crushing resistance of the toner. In the toners of Comparative Examples, each of the toners was finely cracked due to mixing stress caused by the weight of the carrier and the circumferential speed of the developing roller. The finely cracked toner covered the surface of the carrier and inhibited a contact between the newly supplied toner and the carrier. Thus, in the toners of Comparative Examples, a significant decrease in the charge amount occurred. On the other hand, in the toners of Examples according to the present disclosure, the crush resistance was improved, and it was confirmed that the above-described phenomenon did not occur.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2024-043658 filed on Mar. 19, 2024, is incorporated herein by reference in its entirety.

What is claimed is:

1. A polyester resin composition comprising a polyester resin, wherein,
among top 20 peaks in relative abundance in a chromatogram obtained by pyrolysis gas chromatography mass spectrometry, a total number N of peaks having a retention time shorter than or equal to a retention time of 4,4′-dihydroxybiphenyl is 1 to 17, and
the polyester resin composition further comprises at least one element selected from boron, aluminum, and phosphorus.

2. The polyester resin composition according to claim 1, wherein a total content of boron, aluminum, and phosphorus is in a range of 300 to 3000 ppm by mass relative to 100% by mass of a content of the polyester resin.

3. The polyester resin composition according to claim 1, wherein a sum of an acid value and a hydroxyl value of the polyester resin is in a range of 200 to 1000 mg KOH/g.

4. An electrostatic charge image developing toner comprising the polyester resin composition according to claim 1 in a range of 30 to 97% by mass.

5. The electrostatic charge image developing toner according to claim 4, having an average circularity in a range of 0.950 to 0.995.

6. A developer comprising:
the electrostatic charge image developing toner according to claim 4; and
a carrier that has a specific weight in a range of 4 to 6 g/cm³ and a volume average particle size in a range of 20 to 40 μm.

7. An image forming method using a developer that includes the electrostatic charge image developing toner according to claim 4.

8. The image forming method according to claim 7, comprising forming a layer of the developer on a developing roller by a developing unit, wherein a circumferential speed of the developing roller is in a range of 200 to 800 mm/s.
